(19) United States
(12) Patent Application Publication
(10) Pub. No.: US 2008/0052113 A1
(43) Pub. Date: Feb. 28, 2008

(54) SYSTEM, METHOD, AND ARTICLE OF MANUFACTURE FOR MANAGING A HEALTH AND HUMAN SERVICES REGIONAL NETWORK

(75) Inventors: Katherine L. Cauley, Dayton, OH (US); David A. Roberts, Fairborn, OH (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: WRIGHT STATE UNIVERSITY, Dayton, OH (US)

(21) Appl. No.: 11/831,271

(22) Filed: Jul. 31, 2007

Related U.S. Application Data
(60) Provisional application No. 60/834,398, filed on Jul. 31, 2006.

(51) Int. Cl. G06Q 50/00

(52) U.S. Cl. 705/2

(57) ABSTRACT

A method and health information exchange system for health and human care providers providing shared community health information records on individuals and their related household members in a secured relational database that is fully HIPAA compliant are disclosed. The system gathers a broad range of medical, epidemiological, and demographic information on individuals and their related household members visiting disjointed and unassociated health and human services providing care in a predefined region. The database is accessible to authorized subscribers via a secure private web site in real time, and allows for the tracking of service utilization of the individuals and their related household members in the predefined region to help ensure that the individuals and their related household members are receiving the necessary care from the variety of disjointed and unassociated health and human services.

### STATEMENT OF GOVERNMENT INTEREST

An award from the Health Resources and Services Administration of the US Department of Health and Human Services was used in the development of this invention. Accordingly, the invention described herein may be manufactured and used by and for the Government of the United States of America for Governmental purposes without the payment of any royalties thereon or thereto.

### FIELD OF THE INVENTION

The present invention relates generally to information management systems and, more particularly, to a network-based distributed health information exchange system and method for disjointed health and human service providers in a regionally defined area.

### BACKGROUND OF THE INVENTION

For over thirty years there has been a clear understanding that health care in this country would be vastly improved if health care providers had real time access to the comprehensive set of health related information available for each patient. Web based technologies that allow for secure transmissions of protected health information are widely recognized as critical to both quality improvement and cost reductions in the health care industry. However, currently, most health related information for an individual patient is resident, on average, in at least seven different locations within one community. For example, a primary care provider has one set of data, multiple medical specialists have additional sets of data, various laboratories, outpatient procedure and urgent care facilities have additional sets of data, pharmacies, emergency departments, and inpatient facilities have additional sets of data. Although much of the data is duplicative, each provider also has data unique to the record resident in her office.

Within the health care industry, the estimated 8% of provider/organizations investing in health information technology are focused primarily on inpatient services, and importing legacy data. Most commonly adopted health information technology (HIT) services are practice management systems that maintain electronic appointment books, insurance inquiries, and billing information for a particular provider organization. Larger provider systems have been outsourcing review of laboratory results using electronic health information technology, and implementing enterprise systems that electronically integrate multiple services and documentation within the hospital.

For the most part, the early adoption of HIT has been in the private sector and has focused on improved quality of care and reduced administrative cost and burden for individual provider systems. There are a plethora of proprietary products being developed or customized by vendors for provider organizations with little to no attention focused on interoperability across products to facilitate the exchange of information from one provider system to another. Additionally, vended systems are typically written on platforms that require purchase of less accessible software and have had multiple layered functionalities requiring extensive programming for interface between systems or previous versions of the same system. Little attention to date has been focused on outpatient services, and even less attention has been focused on health care services provided in the public sector to those patients without health insurance.

The remaining 92% of the health care industry is still watching and waiting—primarily because there remain very few national standards for products and processes development in the industry, and because of the prohibitive cost involved in the migration from paper to electronic records. Additionally, most potential users are reluctant to purchase proprietary systems developed by vendors and customized for each individual provider or provider network, because there is not yet a strong market incentive for these systems to be able work together, that is, they are not routinely interoperable.

Health and human services organizations, which provide outpatient services for those lacking health insurance, are required to comply with federal privacy and security regulations under the Health Information Portability and Accountability Act (HIPAA). Currently, there is no standards-based health information technology that is readily adaptable to existing non-compliant systems. In addition, public health and emergency preparedness organizations need to quickly access and map information from health information records related to outbreaks of infectious diseases, or the impact of biohazards as documented through client/patient encounters at multiple public sector facilities.

### SUMMARY OF THE INVENTION

It is against the above background that the present invention provides an electronic health information exchange system for disjointed health and human service providers in a regionally defined area, such as a state or county to improve access to healthcare and care management for those individuals and their related household members typically lacking health insurance. The system is implemented over a public network, such as the Internet, through a virtual private network and provides a secure private web site. Via the private web site, the system provides web pages to view and input information in health information records maintained in a relational database. The system permits authorized users to record demographic information at the individual and household levels, as well as services utilization data of the individual and related household members in the health information records. With such records, the system facilitates more efficient and effective enrollment of people into available health and human services in the region, and to help ensure that the participating individuals and their related household members are receiving the necessary care from the variety of disjointed health and human services.

The above noted and additional advantages and features of the present invention will be apparent from the following description and the appended claims when taken in conjunction with the accompanying drawings.

### BRIEF DESCRIPTION OF THE DRAWINGS

FIG. 1 is a schematic diagram of an illustrative system with a plurality of components in accordance with an embodiment of the present invention;

FIG. 2 is a schematic diagram of a representative hardware environment in accordance with an embodiment of the present invention; and

FIGS. 3-35 are various screen images of a user interface embodiment for accessing, composing and reviewing live health information records.

### DESCRIPTION OF THE INVENTION

The following description of the embodiments of the invention directed to a network-based distributed information management system, method, and article of manufacture for managing a health and human services regional network is merely exemplary in nature, and is in no way intended to limit the invention or its applications or uses.

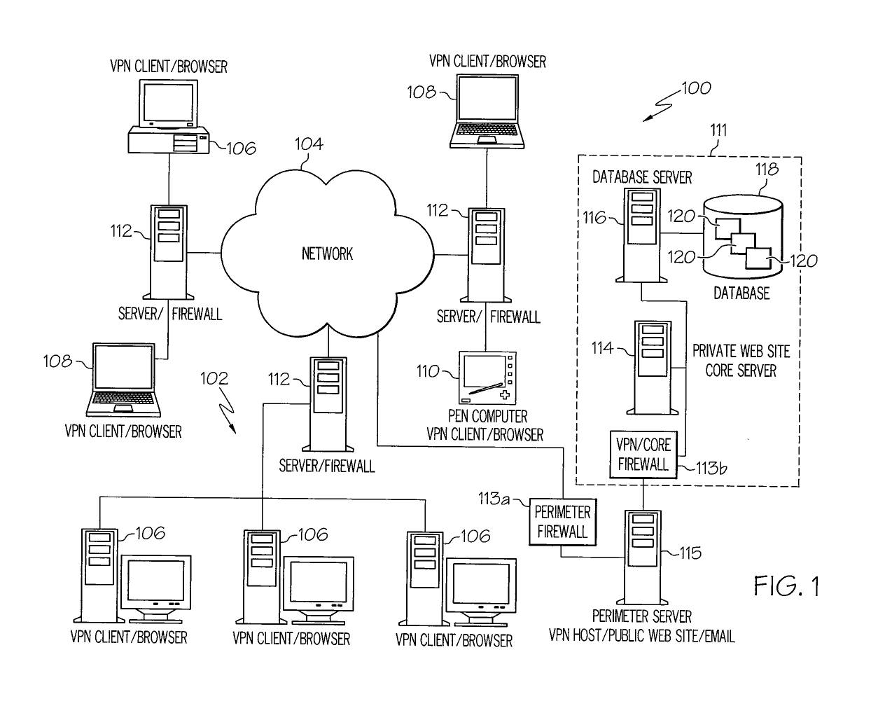

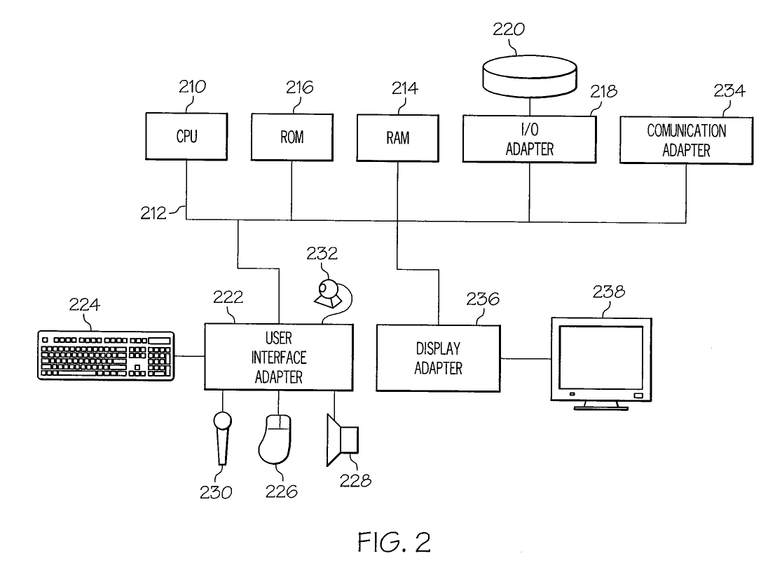

FIG. 1 illustrates an exemplary distributed regional health information exchange system 100 with a plurality of components 102 in accordance with an embodiment of the present invention. As shown, such components 102 include a public network 104 which take any form including, but not limited to a local area network, a wide area network such as the Internet, etc. Coupled to the public network 104 is a plurality of computers, which may take the form of desktop computers 106, laptop computers 108, hand-held computers 110, or any other type of computing hardware/software. Various computers in the system 100 are connected to the public network 104 by way of a server 112, which is equipped with a firewall for security purposes. A representative hardware environment associated with the various components 102 of FIG. 1 is depicted in FIG. 2.

FIG. 2 illustrates a representative workstation 200 by which embodiments of the present invention may be carried out. In the present description, the various sub-components of each of the components 102 may also be considered components of the system 100. For example, particular software modules executed on any component 102 of the system 100 may also be considered components of the system 100. The hardware configuration of the workstation 200 illustrated in FIG. 2 includes a central processing unit 210, such as a microprocessor, and a number of other units interconnected via a system bus 212.

The workstation 200 further includes a Random Access Memory (RAM) 214, Read Only Memory (ROM) 216, and an I/O adapter 218 for connecting peripheral devices such as disk storage units 220 to the bus 212. The workstation 200 further includes a user interface adapter 222 for connecting a keyboard 224, a mouse 226, a speaker 228, a microphone 230, a video camera 232, and/or other user interface devices such as a touch screen (not shown) to the bus 212. The workstation 200 further includes a communication adapter 234 for connecting the workstation 200 to the public network 104 (FIG. 1) and a display adapter 236 for connecting the bus 212 to a display device 238. The workstation 200 typically has resident thereon an operating system such as, from Microsoft, IBM, MAC, UNIX, or LINUX. Those skilled in the art will appreciate that the present invention may also be implemented on platforms and operating systems other than those mentioned. For example, the workstation 200 could alternatively be a graphical terminal connected to a mainframe, mini-, or super-computer.

In general, enrolled referring health and human service provider personnel have secure access to the regional health information exchange system 100 according to the present invention via a public key encryption system using Virtual Private Network (VPN) software or hardware or SSL-class security. In one embodiment, the system 100 is implemented and communicates over the network 104 utilizing TCP/IP and IPX protocols, with data transport across the network 104 carried out via Virtual Private Network encryption, or encryption via wavelet compression or other comparable technique. Password access and public key encryption, preferably in accordance with the Health Information Portability and Accountability Act (HIPAA) is used throughout the system 100.

As shown by FIG. 1, the health information exchange system 100 further provides an internal network or core domain 111 which is protected from the public network 104 by a series of firewalls, namely, a perimeter firewall 113a, and a core firewall 113b. The perimeter firewall 113a protects a perimeter application server 115 by determining what inbound traffic from the network 104 is valid and thus can be passed to the perimeter application server 115 and what is invalid and thus blocked. The perimeter application server 115 acts as the VPN host, public web site server, and email server and is connected to the core firewall 113b which protects an internal network or core domain 111 from unauthorized user access. In the core domain 111, a core server 114 provides further VPN authentication, and acts as the Primary Domain Controller, providing Active Directory services, Internet Information Services, and hosting a .Net framework to authorized users gaining access through the perimeter and core firewalls 113a and 113b via user and password authentication as explained hereafter in later sections. In addition, the core domain 111 has a database server 116 connected to a relational database 118 which stores all the content of the system 100, such as health information records 120. One function of the data server 118 is to use the data in the health information records 120 to automatically fill out a Medicaid application. In addition, all data tables in each of the health information records 120 of the database 118 have been designed to support source and time stamps, as well as associated log tables to audit changes and access operations. This is achieved through a combination of database functions, triggers, and stored procedures which since being conventional, no further discussion thereon is provided. It is to be appreciated that the system 100 has been designed to conform to a scalable multi-tier application architecture built to begin operations with the minimum hardware configuration inside design parameters.

### Authorization

To gain access to the internal network or core domain 111 over the system 100, a user organization must execute a data sharing and business associate agreement with a service provider of the core domain 111 which defines the terms under which authorization to use the system 100 and core domain 111 is granted to both organizations and individuals within organizations. After this organization level agreement is established, the individual user goes to the public website provided by the perimeter server 115 of the system 100 to apply for a password and complete the required information. This information is then transmitted to the system administrator who authorizes access to the core domain 111. When approved, the user then receives an e-mail provided from the perimeter server 115 that will include the user name, password, and instructions on how to install the VPN client software on the user's computer.

### VPN Connection

The VPN client software is required for connection to the core domain 111 of the system 100. In one embodiment, there is an installed capacity of 1500 concurrent user VPN connections in the system 100 to the core domain 111. In one embodiment, there is a special one-time use password to download the VPN Client software provided in the email. In one embodiment, the VPN client software is downloaded from the network 104 via a link provided in the email to the VPN software vendor's server or the perimeter server 115. Instructions on how to install and use the software to access the core domain 111 is also sent to the user via the e-mail authorizing access to the core domain 111.

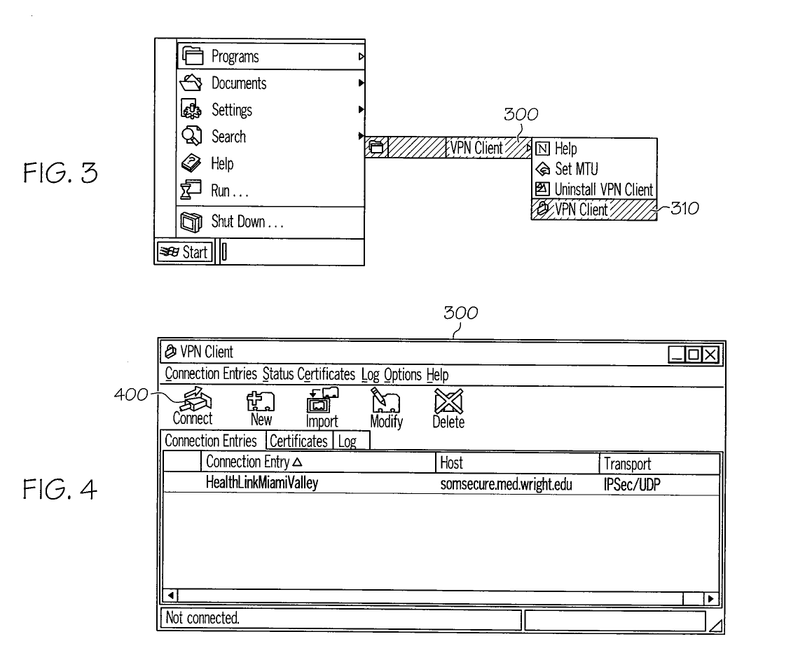

FIGS. 3-35 are screen images of software utilized by the system 100 and of various web pages provided by a private web site embodiment hosted by the core server 114 according to the present invention that authorized users use to compose and review live health information records 120 on a workstation 200 in the system 100 such as described in FIG. 2. The screen images are a non-limiting series of screen shots, which demonstrate some of the fundamental methodology underlying the system 100 and the health information records 120.

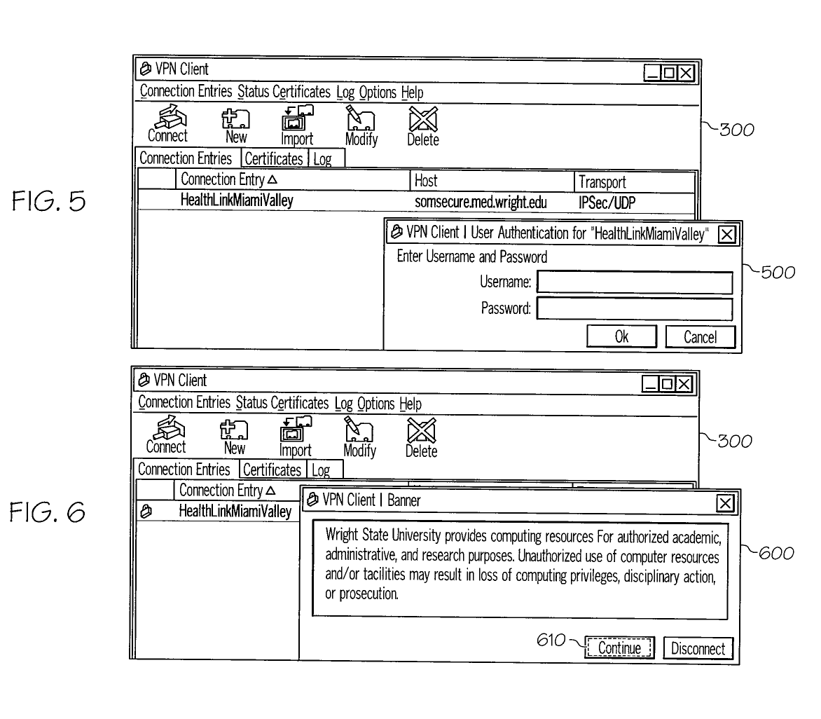

FIGS. 3-5 are screen images showing how a user accesses the core domain 111 of the system 100 using a VPN client program 300. Go to the Start menu on the user computer, click on Programs. In the program list, look for the VPN client program 300, which in the illustrated embodiment is Cisco Systems' VPN Client software. On the extended menu, the user clicks on the VPN Client program icon 310 as shown by FIG. 3. Next, as shown by FIG. 4, the user Click on a “Connect” icon 400 in the VPN program 300. The user will be prompted in a user authentication dialog box 500 provided by the VPN program 300 for the user name and password, such as shown by FIG. 5. The user name and password is provided in the e-mail that was sent to the user when the user was authorized to access the core domain 111.

### Basic Rules of the System

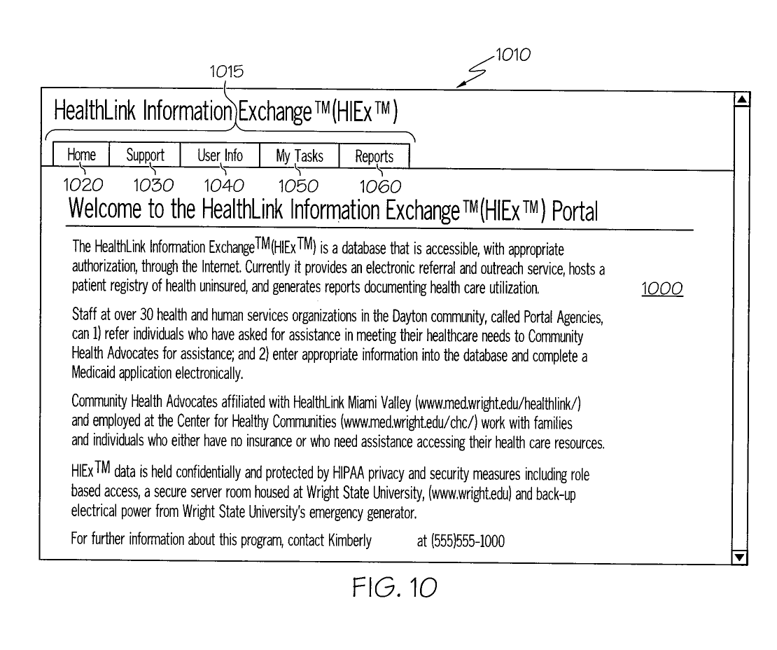

In FIG. 6, after the user is authenticated by the perimeter server 115, the user will then get a VPN Client Banner dialog box 600. After reading the banner information, the user clicks on a “Continue” button 610. The user's display screen will then go back to whatever the user was working on before the user connected to a private web site 1010 (FIG. 10) hosted by the core domain server 114 using the VPN program 300.

The VPN connection must be maintained during the user session with the core domain 111 in order to allow the transmission of information between any one of the user computer 106, 108, 110 and the core server 114. The core server 114 will disconnect if the user connection is idle for 30 minutes. The core server 114 only knows the user is interacting with it when the user makes an action like a submission or a search. If the user is entering data into a form, the core server 114 does not know the user is active until the user sends the data. Therefore, it will not hurt to submit frequently because the core server 114 will update the health information record 120 with each submission. For example, the user may put in a child's name in a demographic form and submit, but then realize that the user spelled the name incorrectly. The user can then go back to the form, select the field where the error occurred, correct the spelling, and submit the form again to the core server 114.

If for some reason the user's connectivity to the network 104 is terminated before the user log out of the VPN client program 300, the core server 114 will retain the user connection for about 20 minutes. If the core server 114 is unaware of the network interruption and the user tries to log in again, the user may not be able to get back in until the user original connection reaches its time out limit. The core server 114 remembers everything the user did. The core server 114 is configured so that health information records 120 are never deleted or erased or written over; any changes the user submits are written as a new line of data. The core server 114 is designed to address HIPAA audit trail compliance, which means that the old information can be retrieved, and most importantly, the core server 114 tracks what user has read a record, what user has changed a record, and what the changes were made to a record.

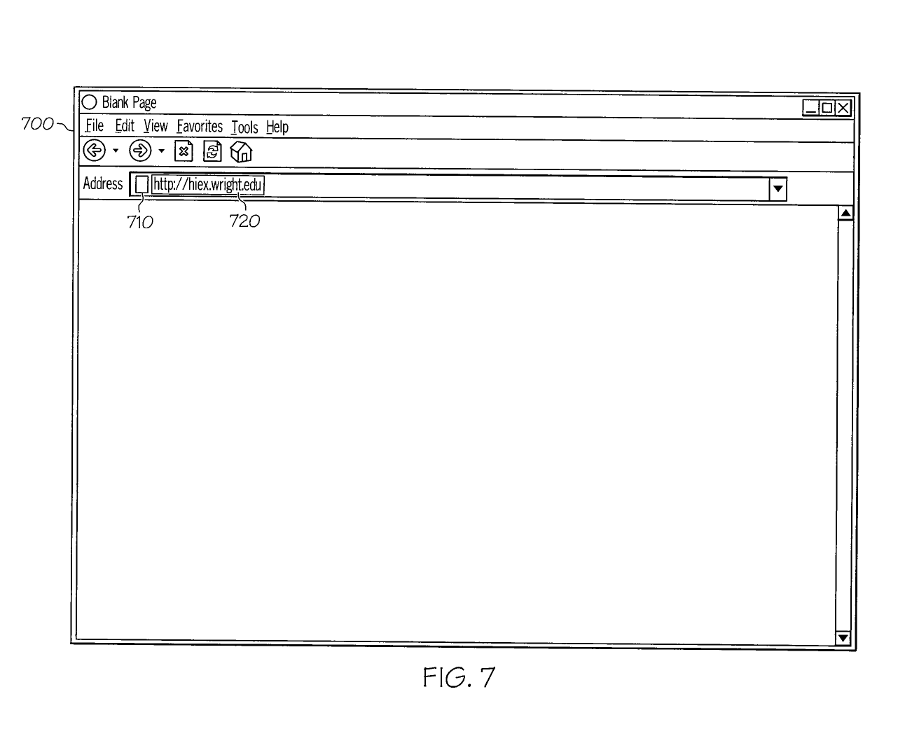

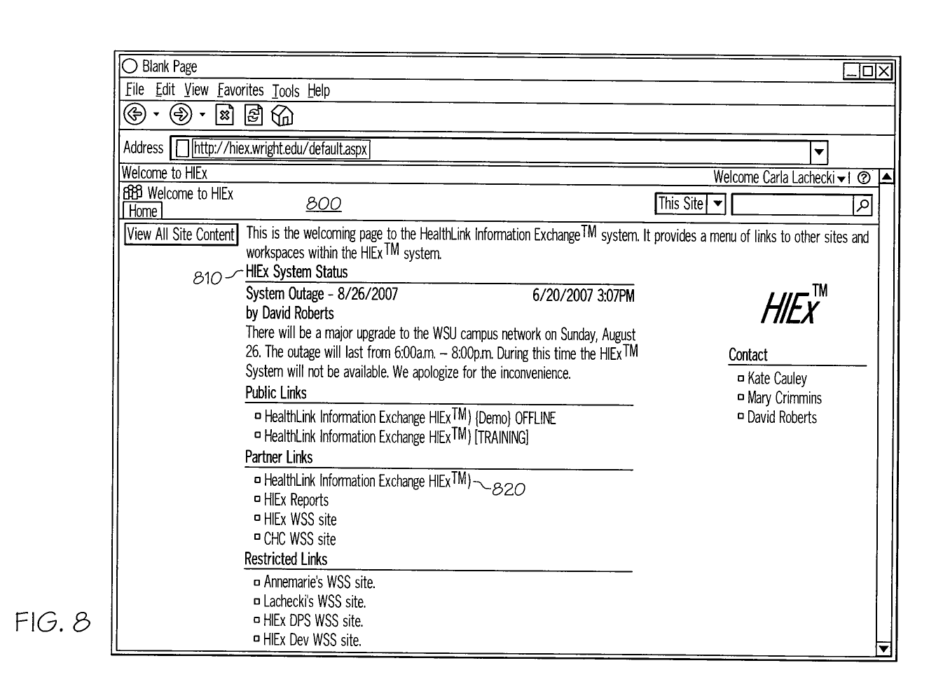

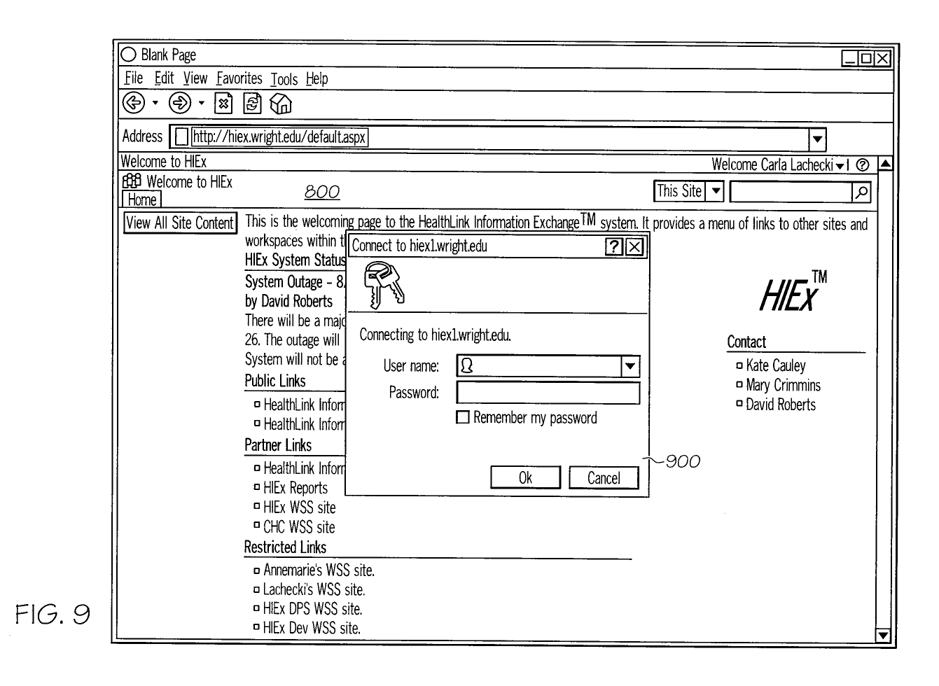

After establishing the VPN connection using the VPN client program 300 through the firewall 113a to the perimeter server 115, the user now opens a web browser 700, which in the illustrated embodiment of FIG. 7, is Microsoft's Internet Explorer. In the address bar 710 of the web browser 700, the user types or selects from a favorites list the domain name address 720 of the core domain 111 of the system 100 and presses “Enter.” If the core domain 111 is up and running with no problems, a start html page 800 will be displayed to the user and, if necessary, provide a system status message 810 as illustrated by FIG. 8. To access the core domain 111, the user then clicks on the HealthLink Information Exchange™ (the system) link 820, which opens a Network Password dialog box 900 as illustrated by FIG. 9. In the Network Password dialog box 900, the user types the same user name and password the user received with the user authorization email from the perimeter server 115.

### General Features of the Core Domain

A home page 1000 of the private web site 1010 in the core domain 111 is then presented to the user by the core server 114, which is illustrated by FIG. 10. To navigate around the private web site 1010 to the home page 1000 and to other pages or forms in the private web site 1010, for example, a tab navigation bar 1015 supporting tab browsing is provided across the top of the page. In the illustrated embodiment, the tab navigation bar 1015 provides a HOME tab 1020, a SUPPORT tab 1030, a USER INFO tab 1040, a MY TASKS tab 1050 and a REPORTS tab 1060 are available to persons authorized as client/patient contact professionals. It is to be appreciated, depending on the access level provided to the authorized user various tabs may be hidden or inaccessible to the user in the tab navigation bar 1015. In addition, the tab navigation bar 1015 dynamically changes to present additional pages that may be tabbed too and viewed from the page in the private web site 1010 that the user is currently viewing.

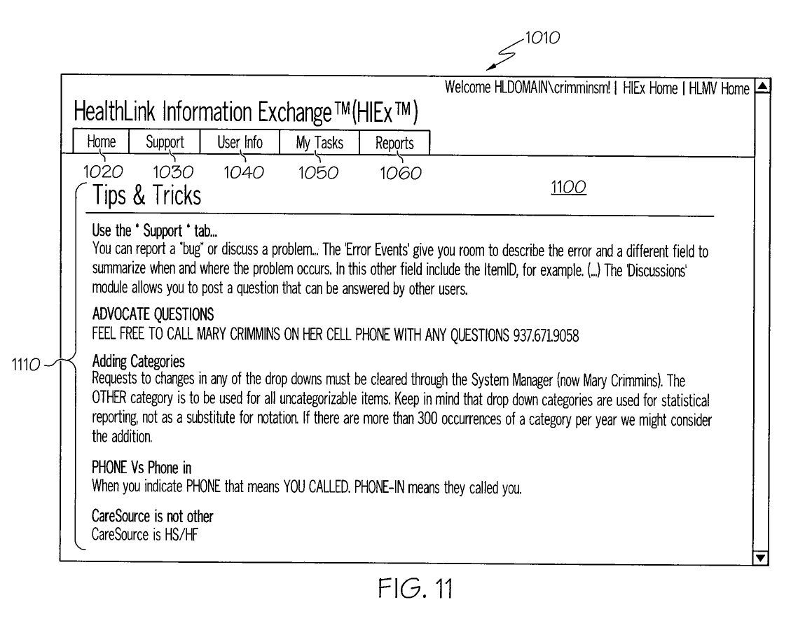

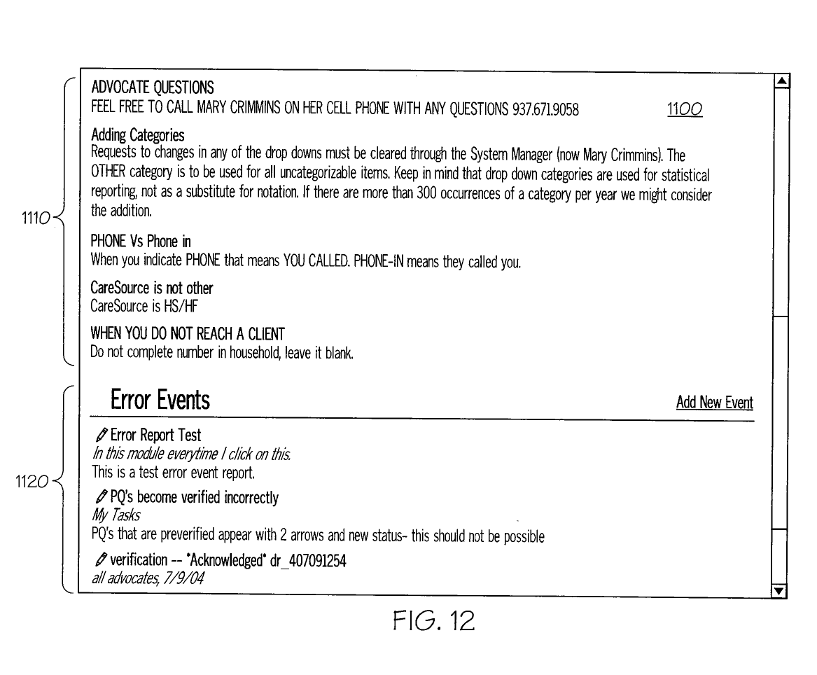

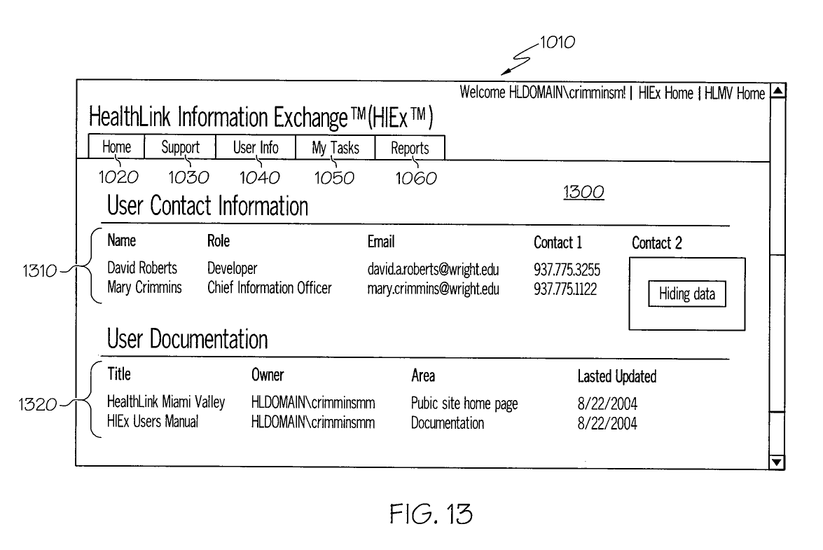

If the user wishes to learn or provide information about the system 100, the user clicks on the SUPPORT tab 1030 to view a SUPPORT page 1100. On the SUPPORT page 1100, users will find user and administrator posting area sections as illustrated by FIG. 11. A TIPS AND TRICKS posting area section 1110 is provided to give administrators and supervisors a place to post information about developing practices and changes in methods of using the system. An ERROR EVENTS posting area section 1120 is also provided on the SUPPORT page 1100 where health advocates and other authorized users who encounter problems can post error events as illustrated by FIG. 12. The noted error events in the ERROR EVENTS posting area section 1120 allow administrators to track problems in both the private web site and database applications. Events are removed once they have been addressed. Errors in the health information records 120 may be recorded also in the ERROR EVENTS posting area section 1120. Selecting the USER INFO tab 1040 will display the USER INFO page 1300 which lists contacts 1310 and documents 1320 posted to the private web site 1010 for user use and reference as illustrated by FIG. 13. The next two tabs—MY TASKS tab 1050 and REPORTS tab 1060—permit access to client information and data reports.

### Searching for Individuals and Households in the System

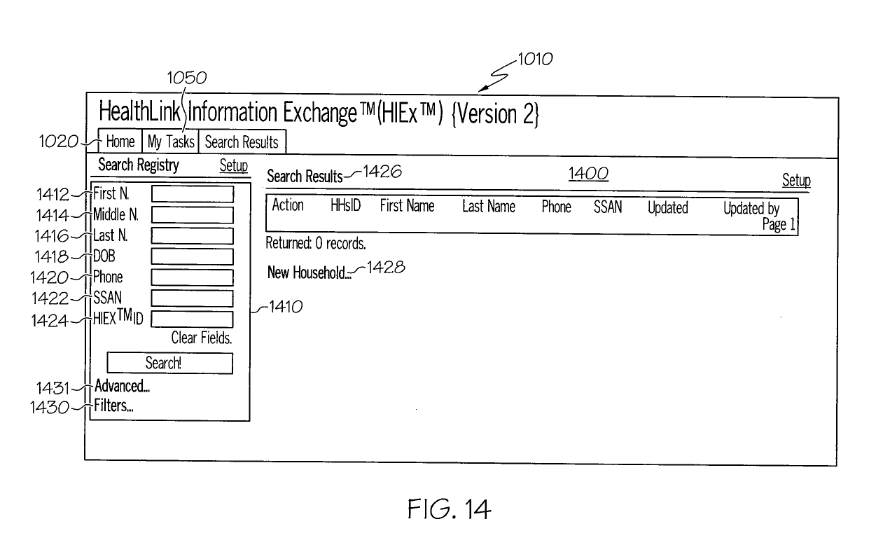

Selecting the MY TASKS tab 1050 will present a My Tasks page 1400 having a search box 1410 which permits the user to see if there is a health information record 120 on a person having a health care encounter with a health and human service provider in the system 100. In the search box 1410 the user inputs what is known of the person in a number of various search term fields as illustrated by FIG. 14. Such search term fields in one embodiment include: first name field 1412, middle name field 1414, last name field 1416, date of birth (DOB) field 1418, phone number field 1420, social security number (SSN) field 1422, and head of household identification number (HHsID) field 1424. In the illustrated embodiment, a search result tab section 1426 indicates that no health information records 120 in the database 118 matched the search terms entered by the user in the search box 1410. At this point, the user two options are to start a new record by selecting a new household record link 1428 provided on the My Tasks page 1400 or to modify the terms search used in the search box 1410. Starting a new household record is covered in a later section; in the following section, additional search options permitted by the private web site 1010 are discussed.

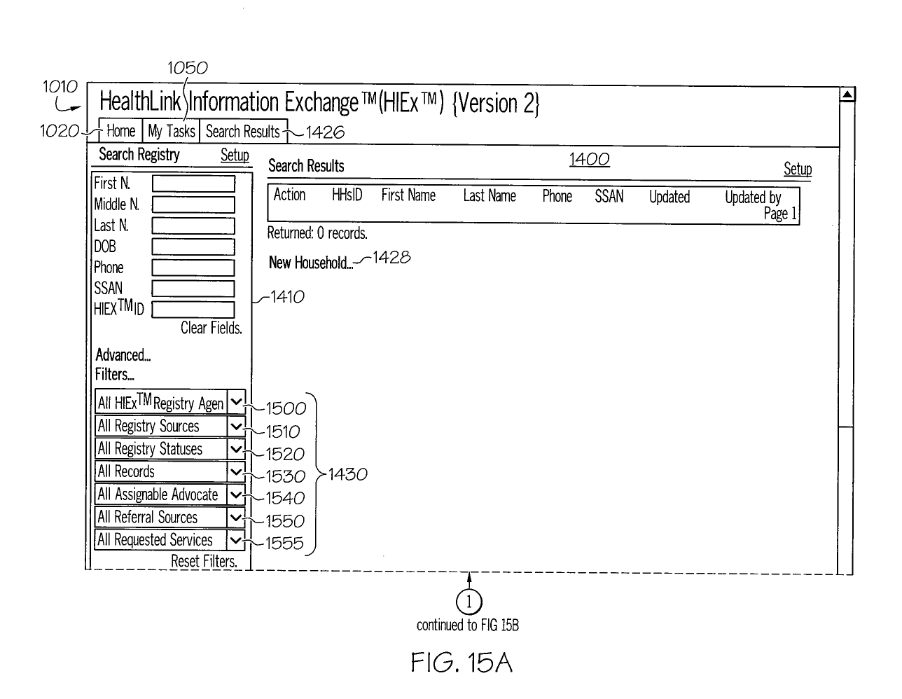

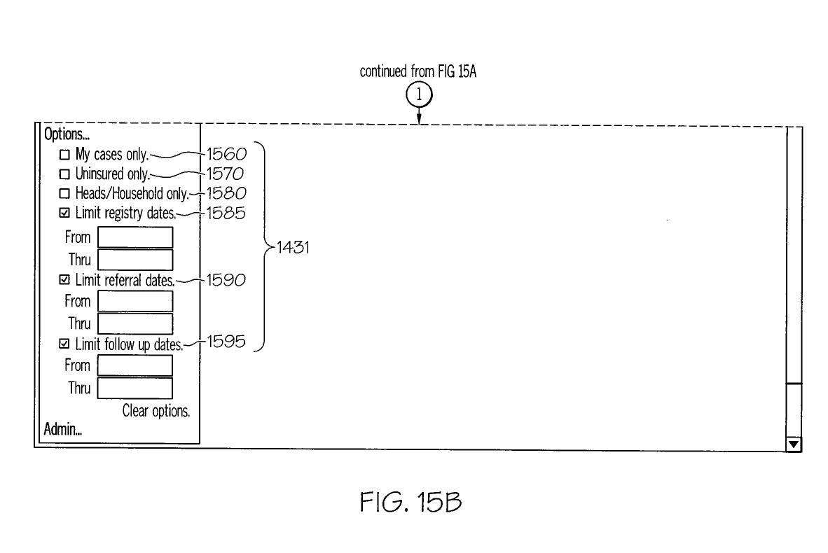

If the user is unsure of the spelling of this person's name, the user can give the search less specific data to produce a larger number of results, for instance. Instead of using the full last name, the user might just include the part of the name that the user is sure about, such as Test, and perhaps just the first initial of the first name. In addition, the private web site 1010 permits advance searching using a variety of filters under a filters section 1430 and options under an options section 1431 which are expanded and shown by FIG. 15.

In the filters section 1430 of the search box 1410 searches can be performed by filtering for a registry agency filter 1500, a registry sources filter 1510, a registry statuses filter 1520, an all records filter 1530, an assignable advocate filter 1540, a referral source filter 1550, and/or a service requested filter 1555. By default, “all” is selected for each filter to provide the most inclusive search. Selecting the registry agency filter 1500 permits the user to search and view only those health information records 120 that have been “started” or registered by a particular agency of the system 100. It is to be appreciated that all registry agencies participating in the system 100 will be shown by a drop down box (not shown) for selection. For example, selecting the referral source filter 1550 allows the user to search and track all or a particular source of each patient referral. The available sources which can be selected individually are provided in a drop down box list (not shown) when the referral source filter 1550 is selected. In many cases, individuals come to a community health center (CHC) from one of the hospital emergency departments, and these individuals are subsequently assisted with Medicaid applications. With this data the user can tell which people came from more than one hospital or agency. Accordingly, the system 100 provides a way in which the user may track the service utilization patterns of individuals and their family members that are associated together under a particular household identification number.

The service requested filter 1555 searches for all or a particular requested service, such as for example, a dental service. The available services which can be selected are provided in a drop down box (not shown) when the service requested filter 1555 is selected. For example, it may be useful when a new resource or agency becomes available in the system 100 to see all health information records 120 intended for that particular service, and to mark the health information records 120 with an indication or message that prompts another health or human service provider who may be seeing the individual to provide such information to the individual and to schedule such an appoint with the new resource or agency. With some of the services for which the users refer an individual it may be also important to know the status of workflow items, which may indicate where there may be potential problems, as in the case where court dockets slow a pro se application process for child custody, or in the case of Medicaid, how many are in a pending status past 90 days. The registry status filter 1520 when selected provides a drop down box (not shown) of such workflow status items, such that a search result of the health information records 120 for such workflow items can be provided to the user to track such problems. The assignable advocate filter 1540 permits the user to search records assigned to a particular advocate, or with an all selection, which provides a filter to delineate all clients assigned to an advocate from those individuals whom have not been assigned to an advocate. The all records filter 1530 w will result in a search of all health information records 120 in the database 118 for individuals on whom demographic data is available and excludes individuals having a “Later” status in their health information record 120 with only contact information. However, in the options section 1431, the user may select a My cases only option 1560 which will result in a search of only those individuals assigned to the user if a designated advocate, an uninsured only option 1570, which will result in a search of only the records of those individual identified as uninsured, and head of household only option 1580, which will result in a search of only those records identified as a head of household. Time periods can also be entered by the user for a registry date range 1585, a referral date range 1590, and a follow up date range 1595.

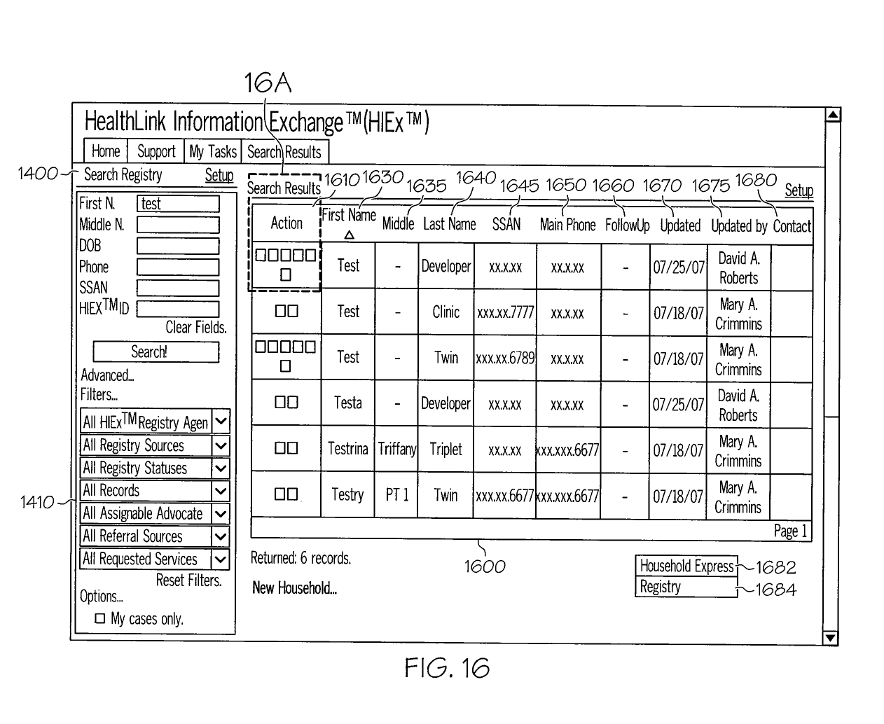

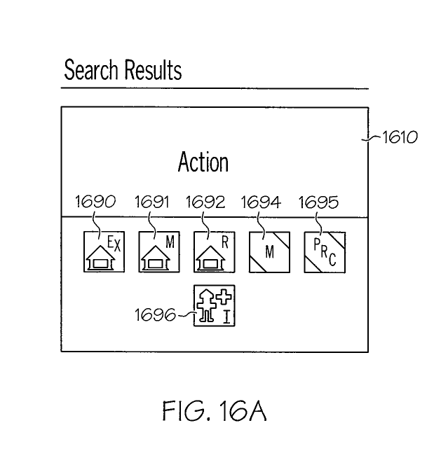

In one illustrated example, a search for a first name “Test” in the search box 1410 resulted in 6 health information records 120 being listed on the search page 1400 in a search result main grid 1600. As shown in the illustrated embodiment of FIG. 16, the main grid 1600 lists in tabular format the following information from the queried and returned health information records 120: action icon(s) 1610, a first name 1630, a middle name 1635, a last name 1640, a social security number 1640, a phone number 1650, a follow-up 1660, a last update date 1670, an updated by indicator 1675, and a contact 1680. For convenience of the user, by default, the search results in the main grid 1600 are sorted first by the entered sort term, in this case first name 1630, and then by head of household. Other sorting of the search result however may be selected by the user double clicking on one of the column headings of the main grid 1600.

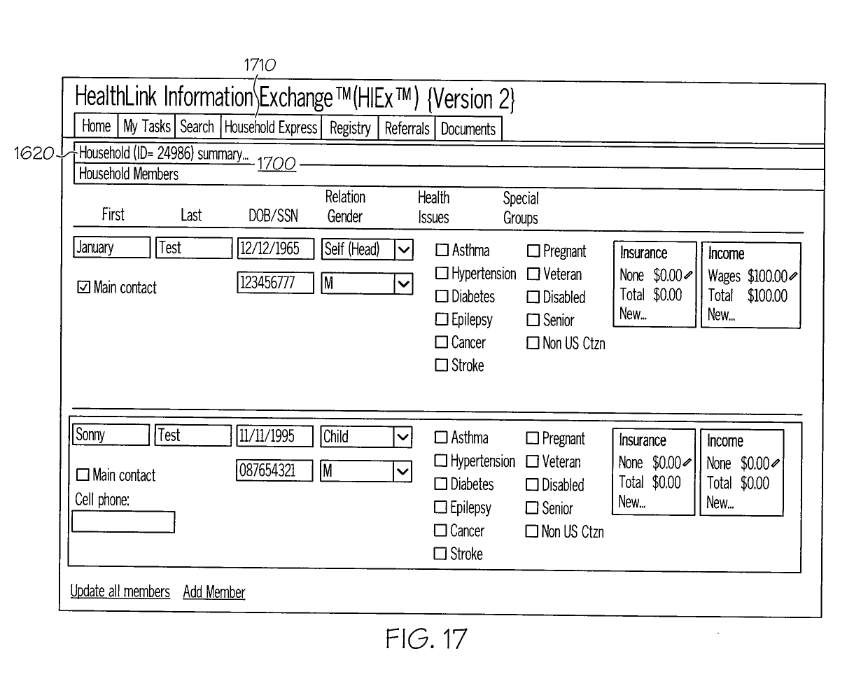

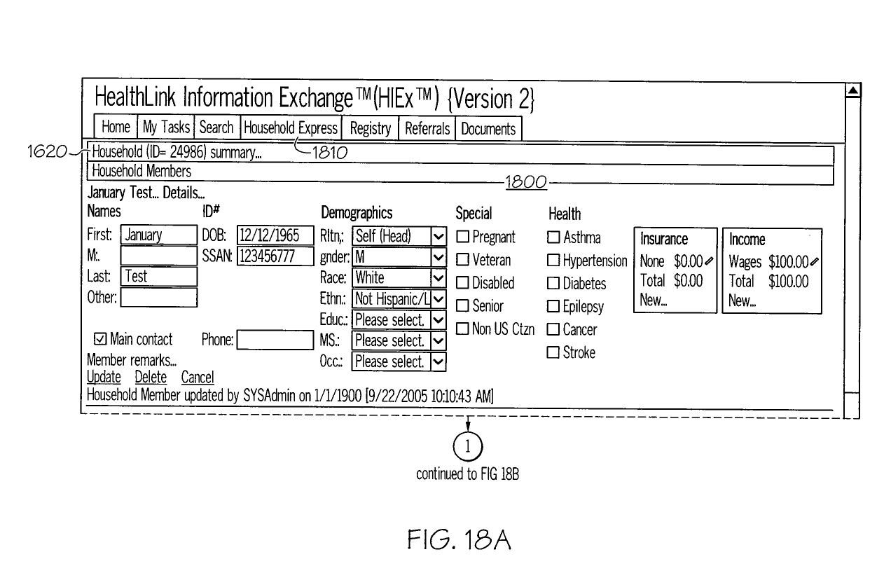

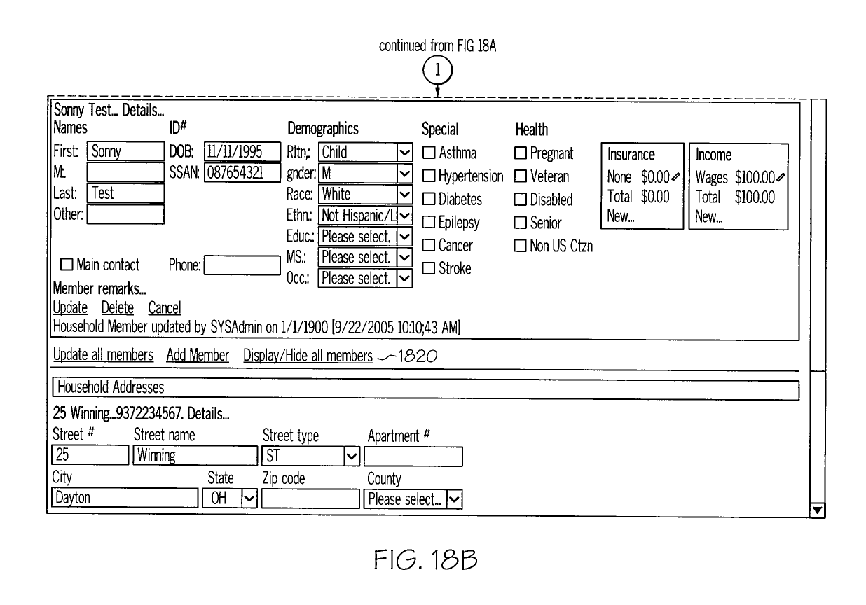

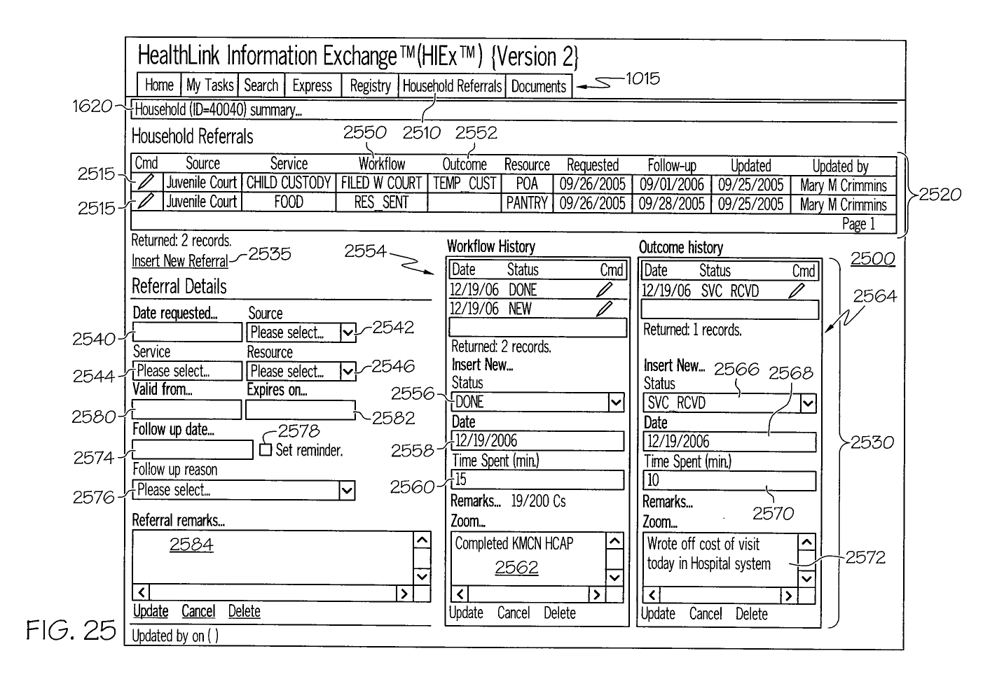

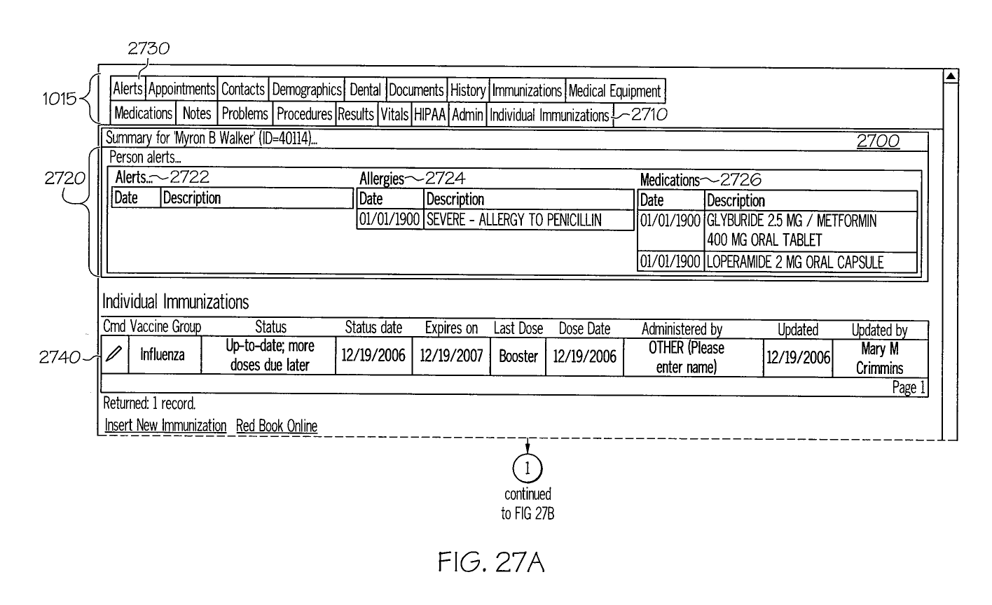

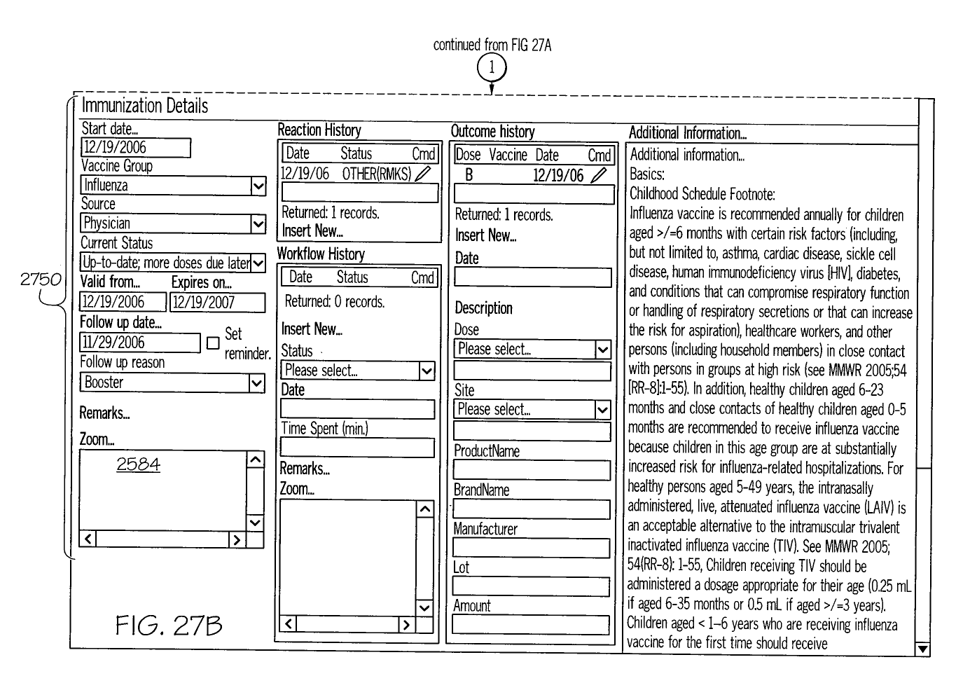

As shown by FIG. 16, Developer Test is the designated head of household since listed first and also having a full array of action icons 1610, and Clinic Test is an individual in the same household as Developer Test. To differentiate who is a head of household and who is an individual, the simplest way to tell is that heads of household have a full array of icons in the search result main grid 1600. As shown by FIG. 16A, a close up section view of the main grid 1600, the following action icons are provided to the user: a Household Express action icon 1690 takes the user to a Household Express summary page (FIG. 17); a Household Members action icon 1691 takes the user to a Household Members section of the Registry page (FIG. 18); a Referrals action icon 1692 takes the user to a Household Referrals page (FIG. 25); a Medicaid action icon 1694 opens an electronic document (e.g., .pdf) providing a Healthy Start/Healthy Families application (not shown) that new individuals filled out during the intake interview, wherein it is to be appreciated that other government program applications may also be provided; a PRC action icon 1695 takes the user to another electronic document (e.g., .pdf) (not shown) also used during the intake summary for the county in charge of the regional health and human services in the health information exchange system 100, and a Person health action icon 1696 takes the user to an Individual Immunization page (FIG. 27) of the individual's health information record 120.

Returning back to FIG. 16, if the user wants to know if there is anyone else in a household, such as for example, with January or Sonny, the user may click the Household Express action icon 1690, the Household Bikers action icon 1691, or right clicks on the mouse 226 (FIG. 2) in any cell of the main grid 1600 in a row for the individual and select either a household express hover tab 1682 or a registry hover tab 1684. FIG. 17 shows a household express summary page 1700 returned after selecting either household express action icon 1690 or the household express hover tab 1682. A household express tab 1710 may also be provided which the user may select to view the household summary 1700. FIG. 18 shows a household registry page 1800 returned after selecting either household registry action icon 1692 or the registry hover tab 1684, which provides the user with the complete health information records 120 for a particular HHsID 1620. A registry tab 1810 may also be provided which the user may select to the household registry page 1800. In addition, each section in the registry view can conveniently be expanded or collapsed via a display/hid selection 1820 at the bottom of each section.

### Entering Client Data

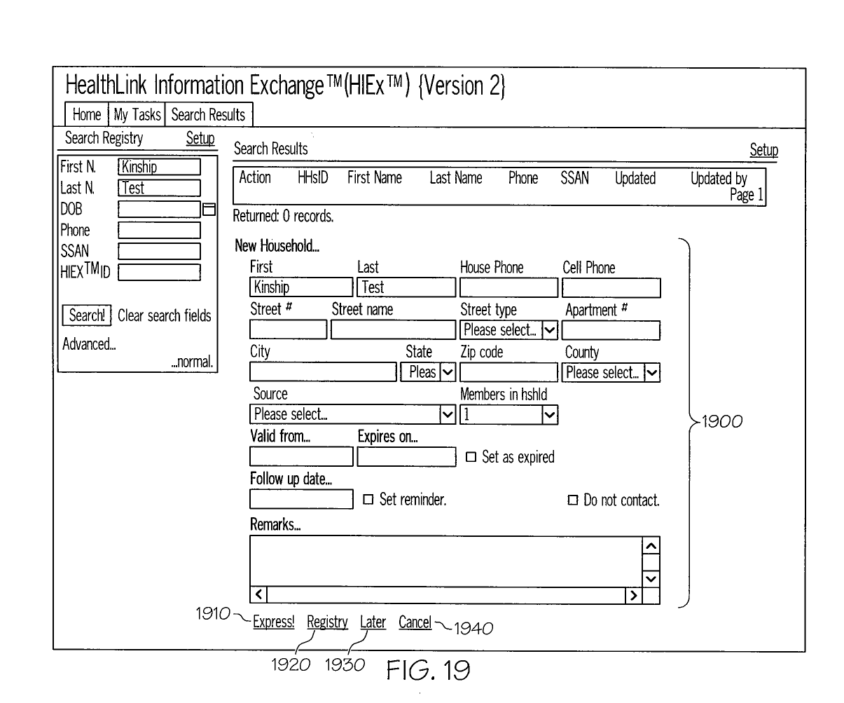

To enter client data into a health information record 120 of the system 100, the user should first search to see if the individual is already in the database 118. For example, as shown by FIG. 14, a search for “Kinship Test” resulted in no record being found in the database 118. Accordingly, the user will need to add the individual as a new health information record 120. To start a new household, the user clicks on the New Household link 1420, which then presents to the user a new household entry form 1900 for populating the new health information record 120 as shown by FIG. 19. The user then enters the available data into the data entry fields provided on the new household entry form 1900, such as for example, name, address, phone number, number of household members, registry source, period record is valid, follow-up date, and remarks. Then the user chooses among an Express entry link 1910, a Registry entry link 1920, a Later entry link 1930, or Cancel entry link 1940, which is self explanatory.

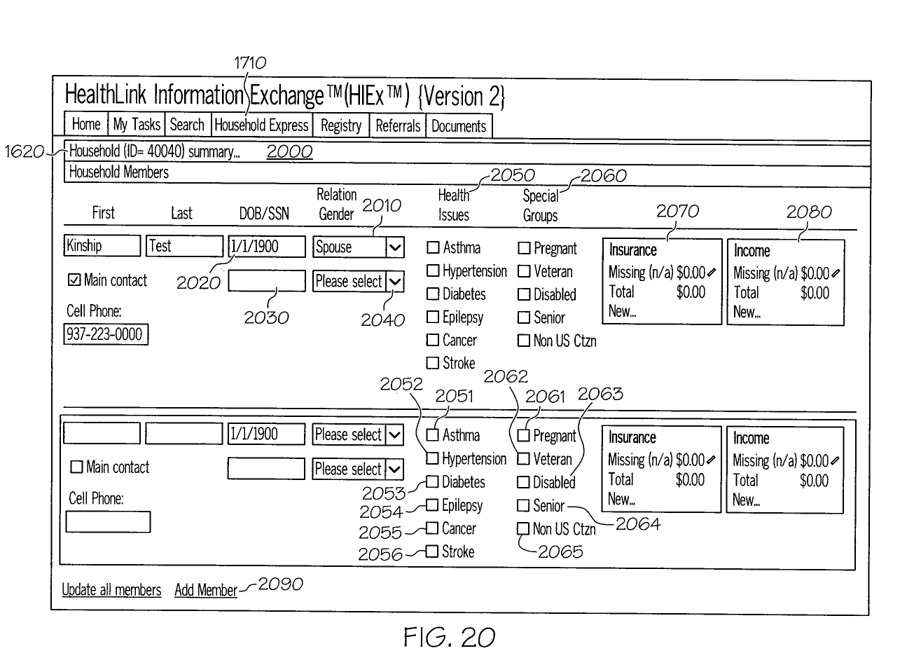

The Express entry link 1910 is selected as a quick way to get basic information of each individual of a household entered into a health information record via an Express entry form 2000, which is illustrated by FIG. 20. It is to be appreciated that the database server 116 will automatically assign a unique HHsID 1620 to the new health information record 120 and to all health information records 120 listed as being a member under the individual designated as “Self(Head)” in a Relation box 2010 provided on the Express entry form 2000. Using the Express entry form 2000, the user may also entry into the health information record 120: a date of birth (DOB) 2020; a social security number (SSN) 2030; gender 2040; self-reported health issues 2050, such as asthma, hypertension, diabetes, epilepsy, cancer, and stroke; special groups 2060, such as pregnant, veteran, disable, senior, and non-US citizen; insurance information 2070; and income information 2080. The user may also enter such data for each additional member of the household, such as for example, “Kinkid Test” the spouse and head of household of Kinship Test as shown in the illustrated embodiment. Additional members can be added under the HHsID 1620 via the Add member link 2090.

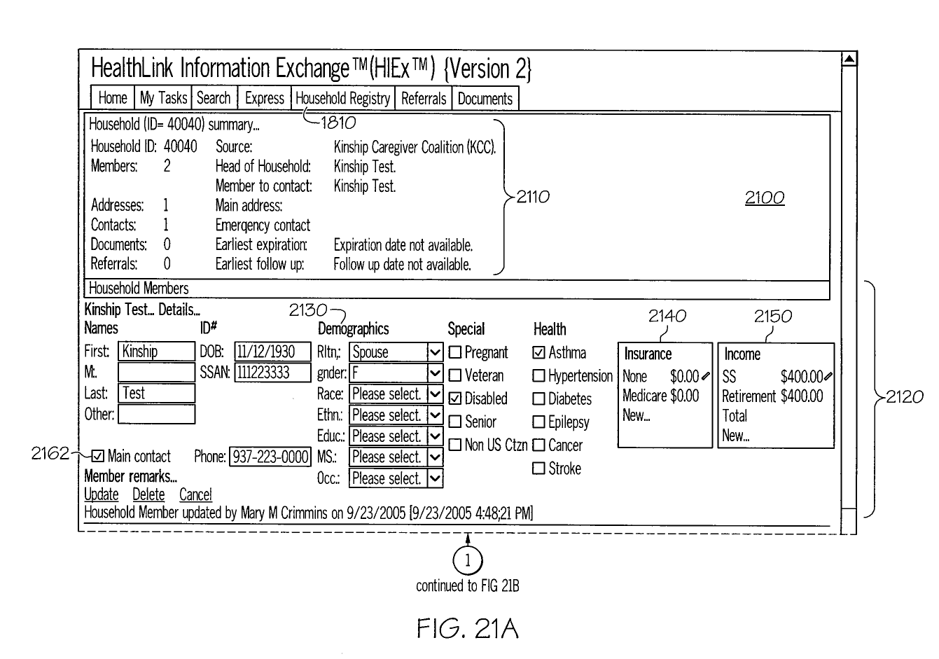

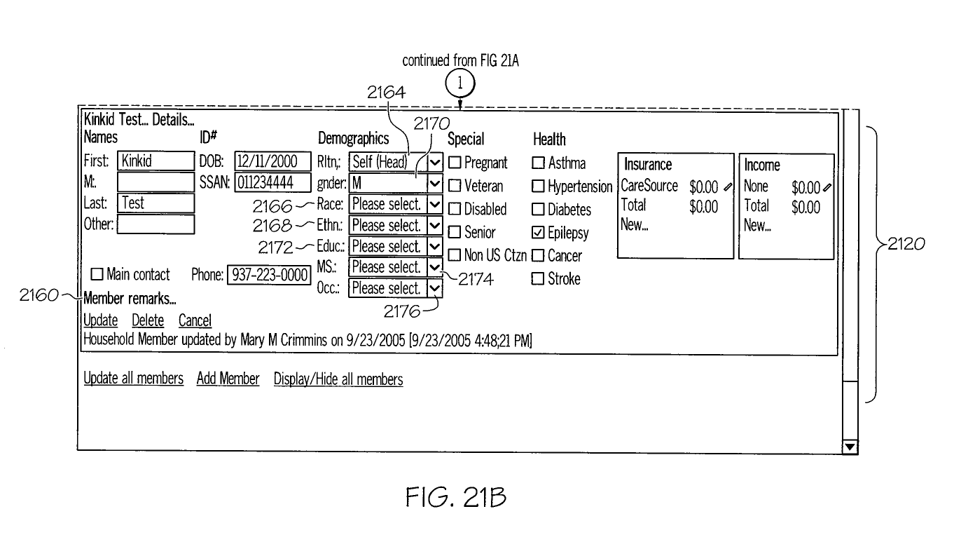

The Registry entry link 1920 (FIG. 19) is selected to enter detailed information known about each individual of a household entered into the health information record 120 via a Registry entry form 2100, which the various sections thereof are illustrated by FIGS. 21, 22, and 23. With reference first to FIG. 21, a Household summary section 2110 is provided at the top of the Registry entry form 2100 which displays the data entered from the Household entry form 1900. Below the Household summary section 2110 is a Household members section 2120. It is to be appreciated that the Household members section 2120 provides data entry fields in addition to those provided on the Express entry from 2000, such as for example, expanded demographics 2130 permitting entry into the health information record 120 data on race, ethnicity, education, marital status, and occupation. In addition, the Household member section 2120 provides income and insurance boxes 2140 and 2150, respectively, which allow the user to add more than one source of insurance or income and the amounts for each. The Household members section 2120 also provides a member remarks area 2160 which permits the user to view information about the health information record 120, such as when last updated and by whom.

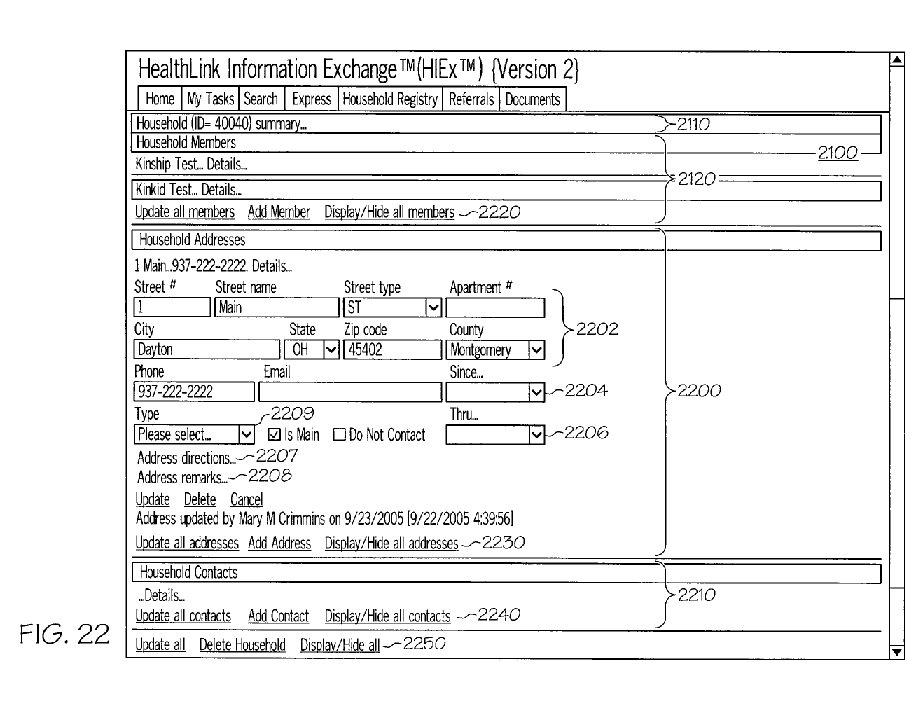

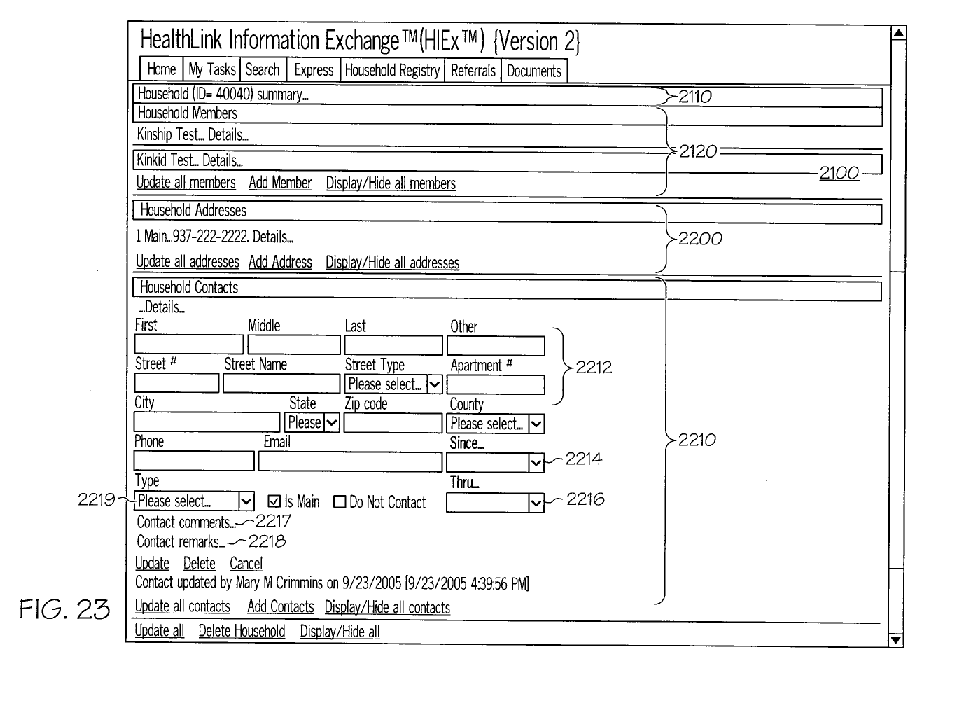

Additional sections of the Registry entry form 2100 include a Household addresses section 2200 and a Household contacts section 2210 as illustrated by FIG. 22. Each of the sections 2120, 2200, 2210 on the registry entry form 2100 can be expanded to show details, including household ID summary and details for each individual, details for addresses and contacts, by using their respective sections Display/Hide selections 2220, 2230, 2240, or for all sections, a Display/Hide all selection 2250 provided at the bottom of the Registry entry form 2100. In the illustrated embodiment of FIG. 22, the Household members section 2120 along with the household summary section 2110, and the Household Contact section 2210 are hidden, with details regarding the Household Addresses section 2200 being expanded, which are self explanatory, and thus no further details are provided. In the illustrated embodiment of FIG. 23, the Household members section 2120 along with the household summary section 2110, and the Household Addresses section 2200 are hidden, with details regarding the Household Contact section 2210 being expanded, which are self explanatory and thus no further details are provided.

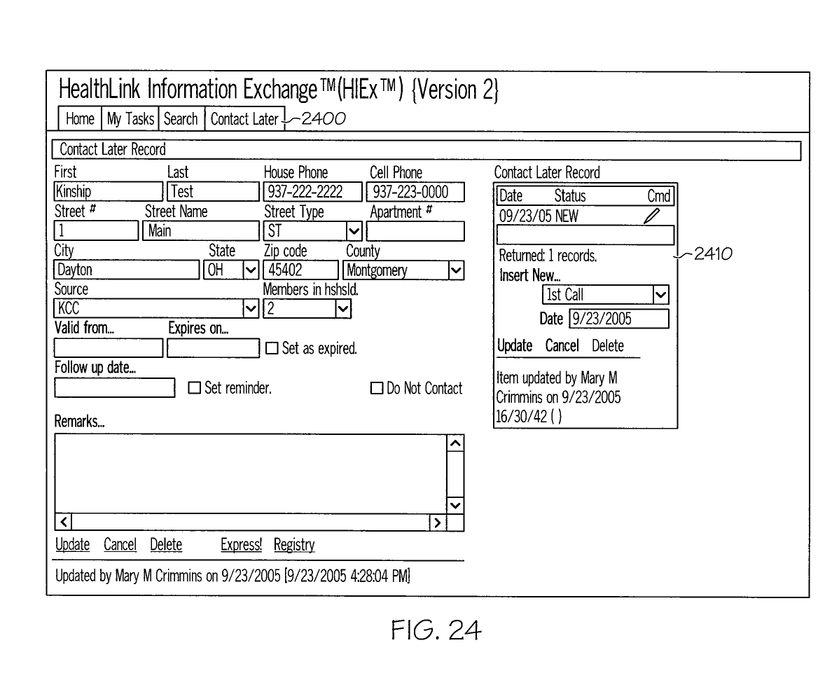

The “Later” entry link 1930 (FIG. 19) is used when there is not enough time to complete the information collection with the individual at an initial interview or even at a later health encounter with any one of the providers of the system 100. If selected, the health information record 120 is then later viewable by selecting a Contact Later tab 2400 as shown by FIG. 24. On the record display in the Contact Later tab 2400, the user can record the history of the contacts in a history box 2410. Typically, this is only completed when the user do not succeed in contacting the individual after the initial intake interview.

### Demographics Definitions

With reference again to FIG. 20, the check boxes provided under the Health Issues category 2050 are used to delineate those health issues that are eligible for disease management programs or special services. These health issues in one embodiment as shown include Asthma 2051, Hypertension 2052 (high blood pressure), Diabetes 2053, Seizure disorder 2054, Stroke 2055, and Cancer 2056. The check boxes under the Special category 2060 relate to the Medicaid application for a state. Selecting pregnant 2061 makes the individual automatically eligible for Medicaid and medical documentation must be provided, which is automatically filled out from the health information record 120 by the data server 118. Checking veterans 2062, Disabled 2063, and Senior Citizens (aged 65+) 2064 will flag the health information record for review for any special service that may be provide to such individuals. Checking Non US citizens 2065 will flag the health information record 120 as not being eligible for Medicaid.

The insurance box 2140 allows users to indicate more than one source of insurance and the monthly amount it costs. Selectable categories under the Insurance box 2140 include in one embodiment NONE (no health insurance), CareSource (Medicaid Managed care program), Medicaid (for low income and disabled), Medicare (for seniors), Military (CHAMPUS), Anthem (private plan usually through employers), United Health Care (private plan usually through employers), and Other.

Referring again to FIG. 21, the income box 2150 allows users to indicate more than one source and amount of income per person. Definitions for each category are: NONE (no income), Wages (indicate total per month), SS Disability (social security disability), SS Retirement (social security retirement), SS Other (other Social Security programs such as those for disabled children, deceased parents, etc.), SSI (Supplemental Security Income for the disabled), and Child Support. It is to be noted that the payment of child support is indicated by placing the minus sign in front of the amount paid, so for example −25 would indicate a $25 per month payment. In addition, due to variations in parentage among household members, the amount of child support received is included as income for the child for whom it is paid. Non-custodial parents can be recorded under household contacts, see below. Other information includes state specific programs, such as for example, in one embodiment, TANF Temporary Assistance for Needy families is a program of the Ohio, Department of Job and Family Services, Workers Compensation, OWF Child Subsidy, Kinship Subsidy, and other such programs. All amounts are considered monthly and are inputted as whole dollars.

Head of household is defined as the person who is filing the Medicaid application, if applicable, or the person to whom the Advocate is speaking. For each individual in the household, information collected includes gender and relation to the head of household. Please note that it is acceptable to be speaking to the wife of a male-headed household. She will appear on the top line of the Demographics Summary, but under Relation to head of Household, she would be identified as “Spouse.” For example, as illustrated by FIG. 21, the individual “Kinship Test” is marked as the “Main contact” in a main contact box 2162 to indicate that she is the individual who gave the latest information. The husband's information “Kinkid Test” appears on the second line. As Kinkid Test is the head of the household; therefore, “Self (head)” is selected in a “Relation to head of household” box 2164 for him in the health information record 120. The selectable choices from the Relation to head of household box 2164 in one embodiment include: Self (head), spouse, aunt/uncle, child, cousin, foster child, friend, grandchild, grandparent, nephew/niece, parent, sibling, significant other, stepchild and other.

Race is not a required item and choices are configurable. Current options are based on individual state Medicaid application requirements and the selectable choices from a race drop down box 2166 include in one embodiment American Indian/Alaskan, Asian, Black/African American, Native Hawaiian, White, Other, and Missing/Refused. Ethnicity is not a required item and the selectable choices from an ethnicity drop down box 2168 include in one embodiment Hispanic or Not Hispanic. Gender in a gender drop down box 2170 is not required and is based on self-report. Education is sometimes a problem as there is often a difference between those who complete 12 years of high school AND those who got a diploma or a GED. Accordingly, the selectable choices from an education drop down box 2172 include in one embodiment 1-8 years, 9-12 years, HS diploma, GED, Some college, Associate degree, Bachelor's, Masters, PhD, and other. The selectable choices from a Marital Status box 2174 include in one embodiment Single, Married, Separated Divorced Widowed, and Other. The selectable choices from an Occupation drop down box 2176 in one embodiment is broken down into typical department of commerce categories, and in other embodiment include: professional, technical, scientist, computer programmer, manager/admin, store manager, program administrator, sales, sales clerk, counter help, insurance sales, clerical, administrative support staff, file clerks, typists, crafts, carpenter, plumber electrician, potter, operatives, tool and die makers, machine operators, transportation, cab drivers, bus drivers, service, hotel staff, waitresses, waiters, laborers, day labor, ditch digger, highway worker, farm owner/manager, farm laborer/foreman, unclassifiable, active military, and special categories (not dept of commerce), disabled, retired, and student.

Referring again to FIG. 22, on the registry page 2100, the user can also change or edit the information provided in the Household Address section 2200 and the Household Contacts section 2210. The Household Address section 2200 shows an address 2202 for the household. In addition to the standard information on the household address 2202, the user can indicate dates which this address has been valid, permitting a housing history for those who need it. To do this the user enters a date into “Since” and “Through” fields 2204 and 2206, respectively. If the user knows that a family is moving, the user uses the Through field 2206 on the old address and the Since field 2204 on the new address. Additionally the user can add directions in a directions posting area 2207, remarks in a remarks posting area 2208, and with an address type drop down box 2209 indicate the type of address. In one embodiment, valid types of addresses include: Home, Shelter, Home (owned), Homeless, Home (renter), Jail, Work, Mailing, Relative, Other, and Friend.

Referring again to FIG. 23, in the Household Contacts section 2210 the user can record personal and professional contacts 2212 for the household. The user can also indicate dates which each contact has been valid, permitting a reference history for those who need it. To do this the user enters a date into “Since” and “Through” fields 2214 and 2216, respectively. Additionally the user can add information from the contact in a contact comments posting area 2217, remarks about the contact in a contact remarks posting area 2218, and with a contact type drop down box 2219 indicate the type of contact. In one embodiment, valid types of contacts include: for personal contacts, Guardian, Non-custodial parent, Biological Father, Biological Mother, Relative, and Friend; for Health contacts, Emergency, Guarantor, Primary Care Physician, Clinic home, Hospital, and Pharmacy; for professional contacts, Caseworker, Social Worker, Case Manager, Probation Officer, Payee, and Employer.

### Referrals

Referring now to FIG. 25, in order to track needs of clients and where they are sent (referred) for services, the user uses a Referral page 2500. The Referrals page 2500 may be viewed by the user by either selecting the House Referrals action icon 1692 (FIG. 16A) from the action icon section 1610 of main grid 1600 on search result page 1400 (FIG. 16) or selecting a Household Referrals tab 2510 when provided in the tab navigation bar 1015. Referrals 2515 listed in a Referrals section 2520 are tracked by the HHsID 1620 and are used to track the process and progress toward completion of all referrals for the household. From the Referral page 2500, the user may update an existing referral shown in the Referral section 2520 by clicking on a listed referral 2515 which populates the existing information in the referral details section 2530 for editing or may add a new referral to the referrals section 2520 by selecting the Insert New Referral selection 2535.

For example, to add a new referral, the user begins by recording a date requested in a Date requested field 2540. In one embodiment, clicking on the Date requested field allow the user to use a calendar pop up to select date. Next, the user can list in a Source field 2542 the source (agency) of the referral. The source filed lists in a drop down box all participating members in the system 100. For example, if a first agency asks the client to contact a second agency to initiate a Medicaid application, them the source is the first agency, or if Juvenile Court asks the client to contact an individual to take care of a child custody issue, then the source is Juvenile Court. Recording the source of the referral permits the user to track beyond the first contact service utilization patterns of the household.

Next, the user selects the type of service requested from a Service drop down box 2544. In one embodiment, the selectable choices include: Child Custody, Childcare, Clothing, Dental, Education, Emergency Shelter, Employment, Financial, Food, Furniture, Housing, Income Programs, Legal, Medicaid, Medical, Mental Health, Optical, Other, PRC Application, Prenatal/Maternity, Prescriptions, Transportation, and WIC. For each of the services types, there is a customized list of resources provided in a Resources drop down box 2546 to which the user may select, and which will change by location, specialty, etc.

As mentioned above in a previous section, the system 100 permits the user to track the progress and process that each referral 2515 takes in order to document problems that may be systemic. The current status of the workflow and outcome for each referral 2515 is shown in Workflow and Outcome cells 2550 and 2552, respectively, listed in the Referral section 2520. The user may update the status of the workflow of each referral 2515 using a Workflow History section 2554 which provides a Workflow Status indicator drop down box 2556, a Workflow Date box 2558, a Workflow Time spent box 2560, and a Workflow Remarks box 2562 for recording such information. In addition, the user may update the status of the outcome of each referral 2515 using an Outcome history section 2564 which provides also an Outcome Status indicator drop down box 2566, an Outcome Date box 2568, an Outcome Time spent box 2570, and an Outcome Remarks box 2572 for recording such information. It is to be appreciated that the outcome history of a household tracks what has happened to the referral in the system 100 and the associated dates permit the user to compare this against standards for performance. For example, it is a problem when a Medicaid application is pending more than 90 days. The system can provide reports on pending status over time because these items show the entire history of both workflow and outcome as shown.

The user may setup a follow up with either clients or other agencies using a Follow up date field 2574 (calendar pop up), and provide a reason in a Follow up reason drop down box 2576. In one embodiment the reasons provide by the Follow up reason drop down box 2576 includes: Client follow up (suggesting calling the client to check on status); Eligibility check (with either client or agency); Final Attempt (need to make a last attempt to contact the client); Letter needed (final attempt made, letter letting client know status); Other; Outcome Information (checking on what the outcome was. e.g. did the client follow up); Recertification date (to remind the client it is time to apply again so there is no lapse in coverage); and Verifications (calling to inform that more substantiation of their economic or other conditions are required). If the user checks a Set reminder box 2578, a message will appear on the users My Tasks page 1050 on the date entered in the Follow up date field 2574. Additional fields include a Validate from field 2580 and Expires on field 2582 to input a time period for the referral 2515, and a Remarks area 2584 for an other information regarding the referral.

### Scanned Documents

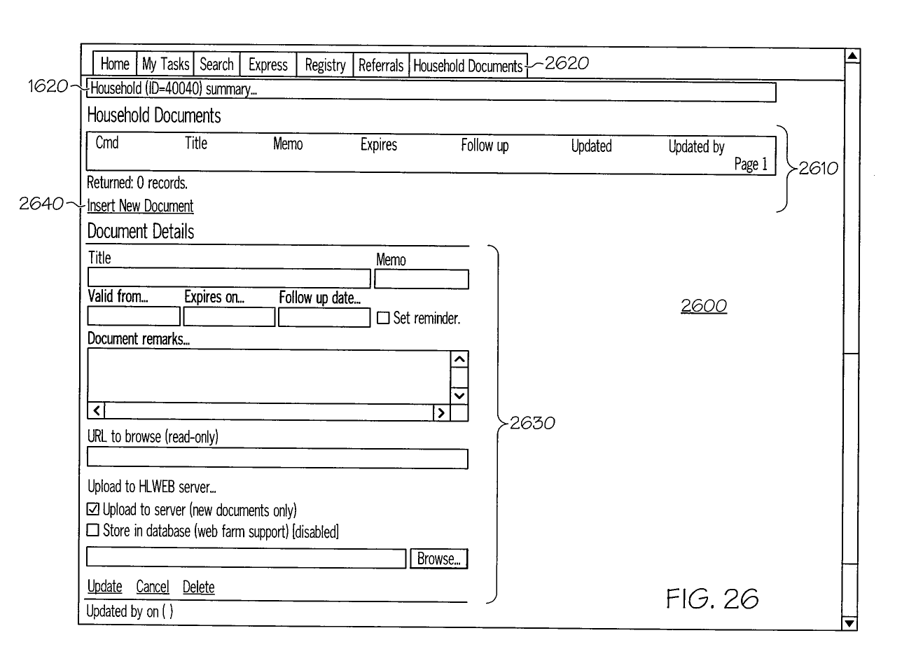

Referring to FIG. 26, a Household Document page 2600 is shown which lists in a document summary section 2610 any documents that have been scanned into the health information record 120 identified by the HHsID 1620. The Household Document page 2600 is viewed by the users selecting the House Documents action icon 1693 (FIG. 16A) from the action icon section 1610 of main grid 1600 on search result page 1400 (FIG. 16) or selecting a Household Document tab 2620 when provided in the tab navigation bar 1015.

Document details are viewable by selecting on any of the listed documents in the document summary section 2610 which populates the fields provided in a Document Details section 2630. The user clicking on a Add new document selection 2640 will clear the fields provided in the Document Detail section 2630 if populated such that the information regarding the new document can be entered. As the fields shown in the Document Details section 2630 are either self explanatory or function in the same manner as other similar fields in other Details sections of the private web site 1010, for brevity, no further details regarding are provided.

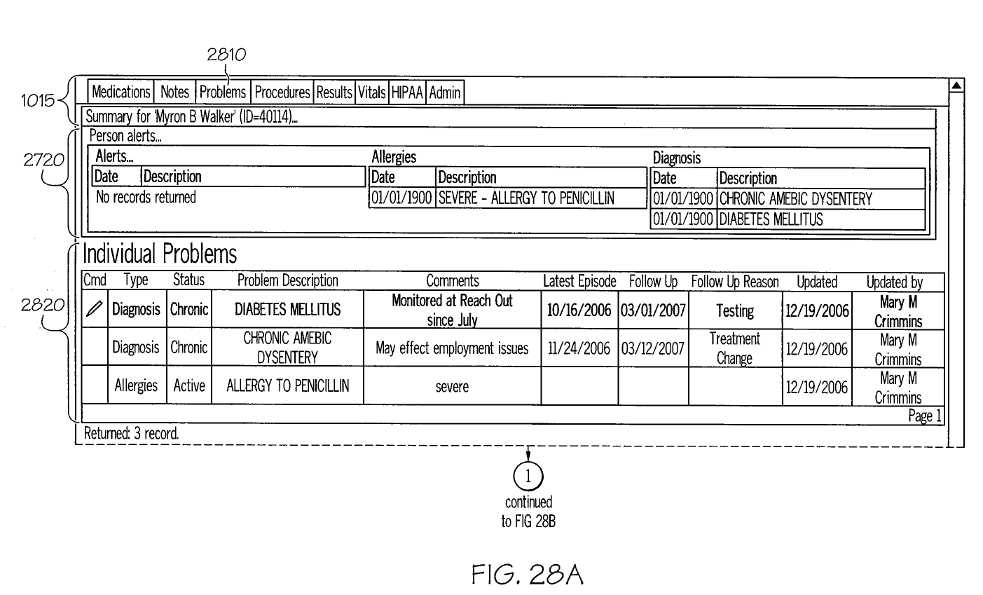

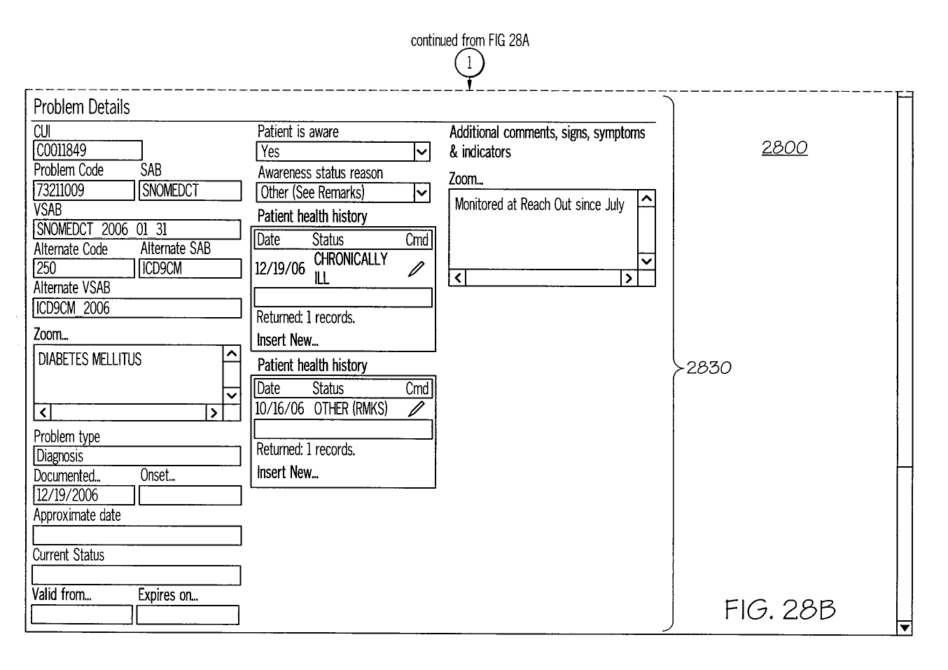

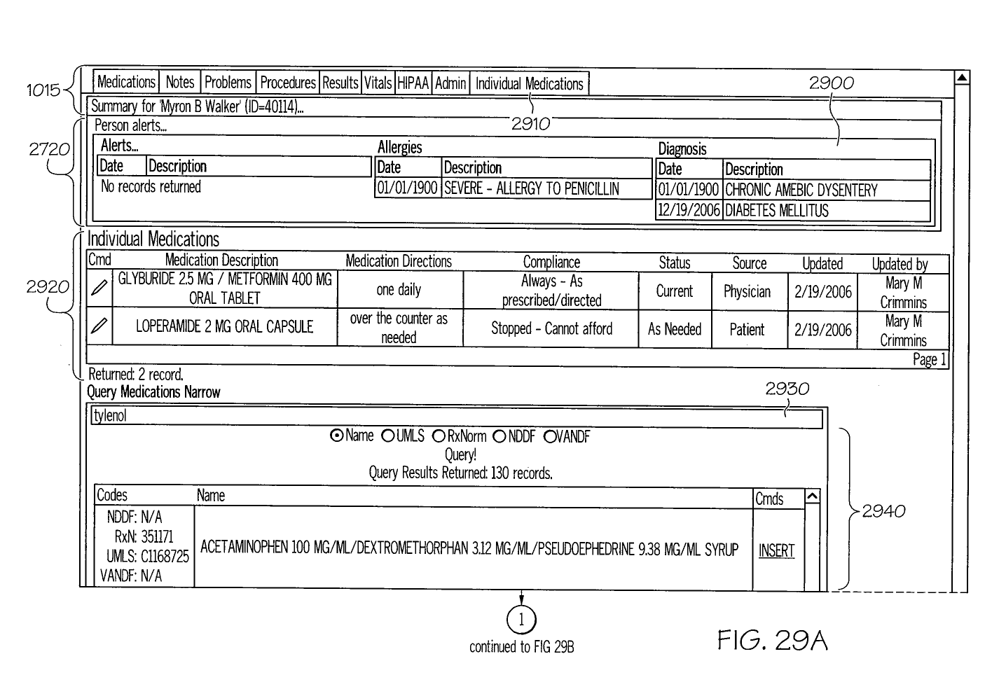

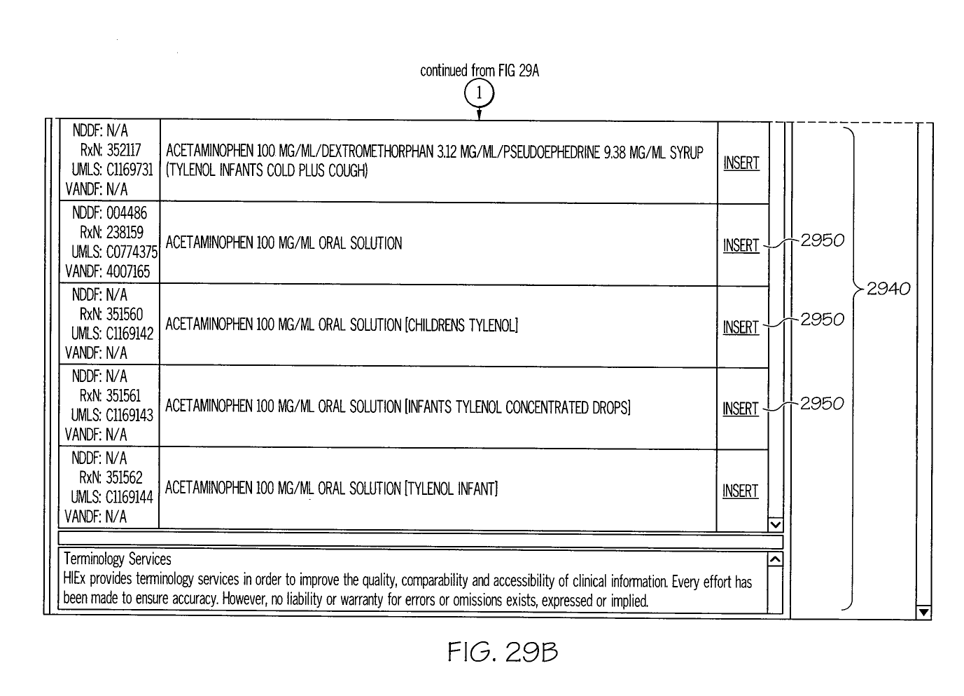

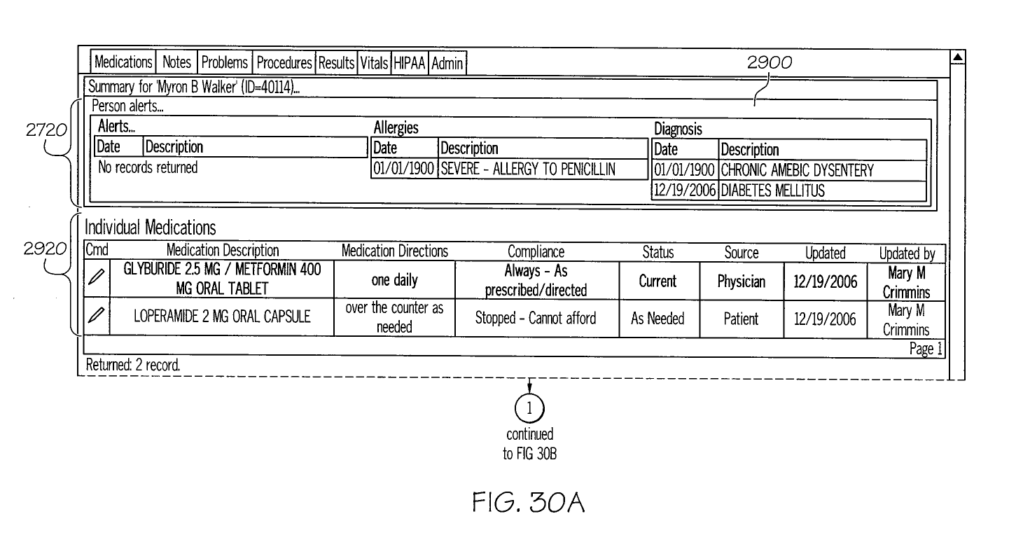

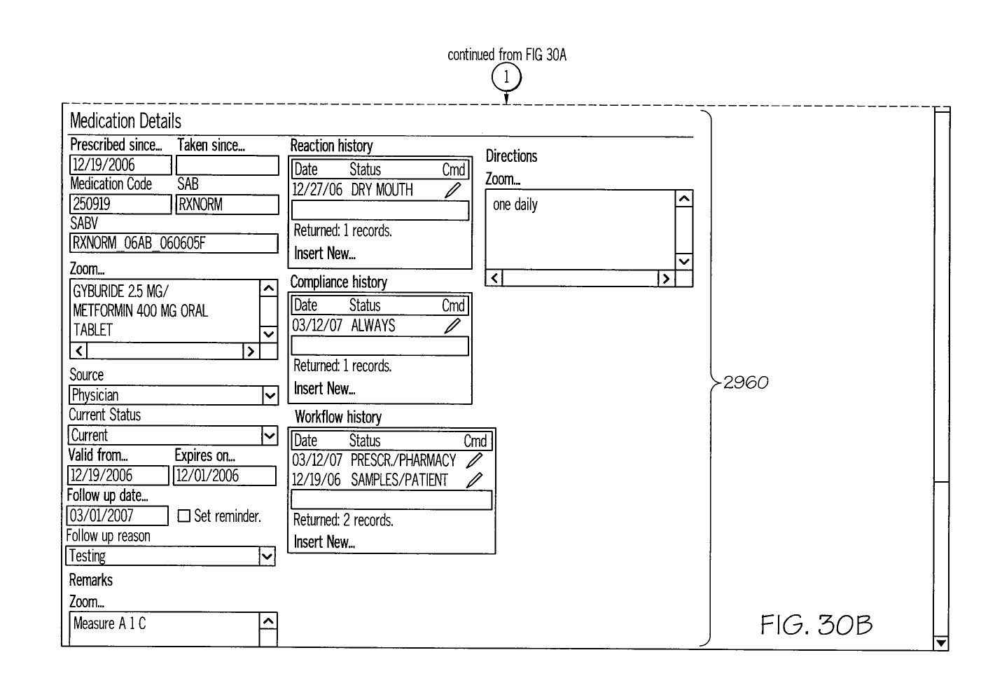

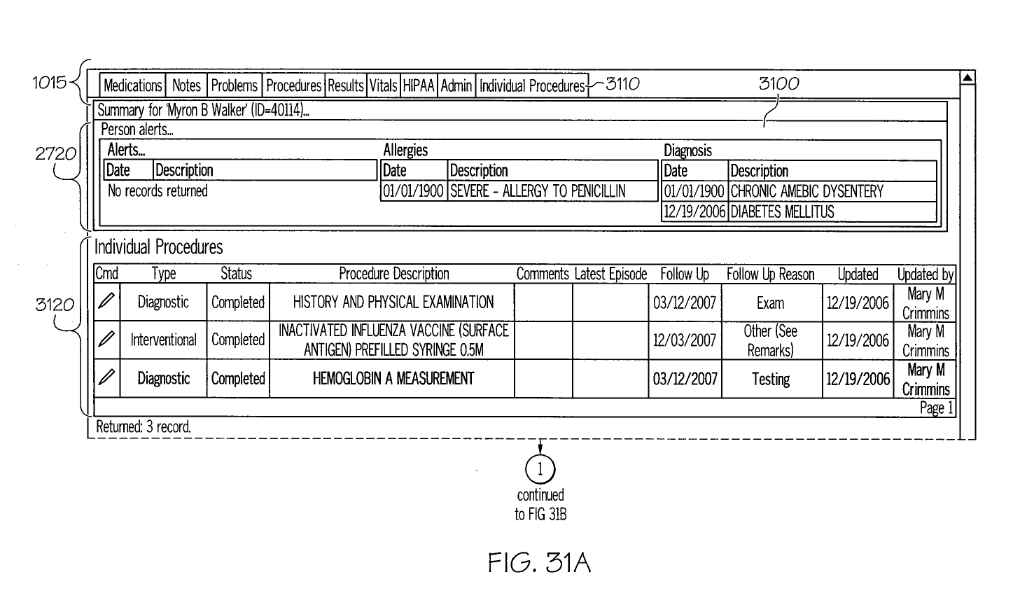

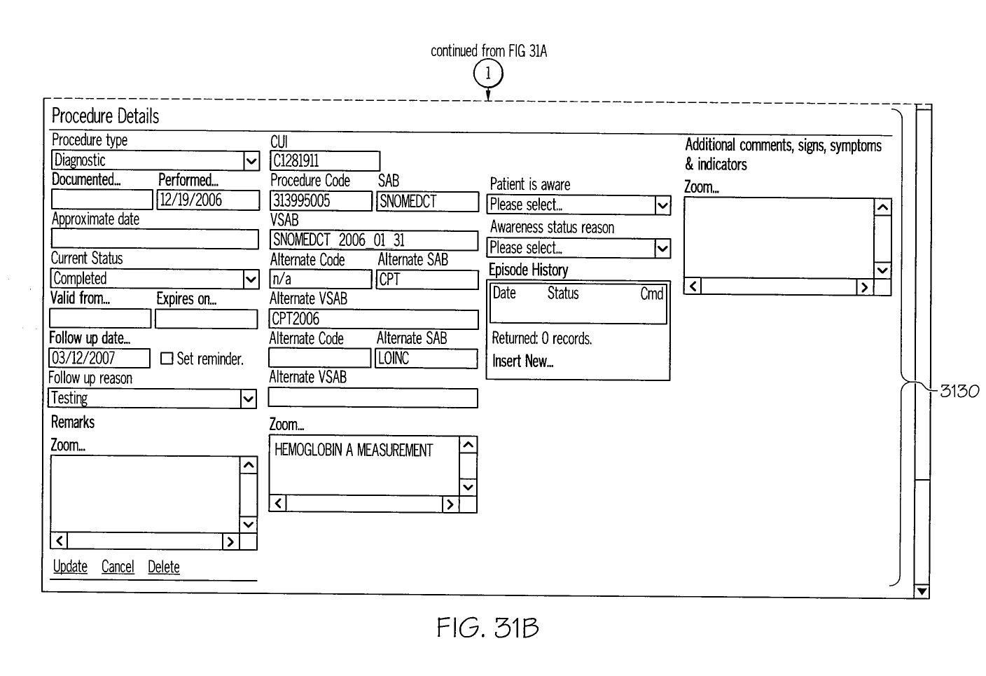

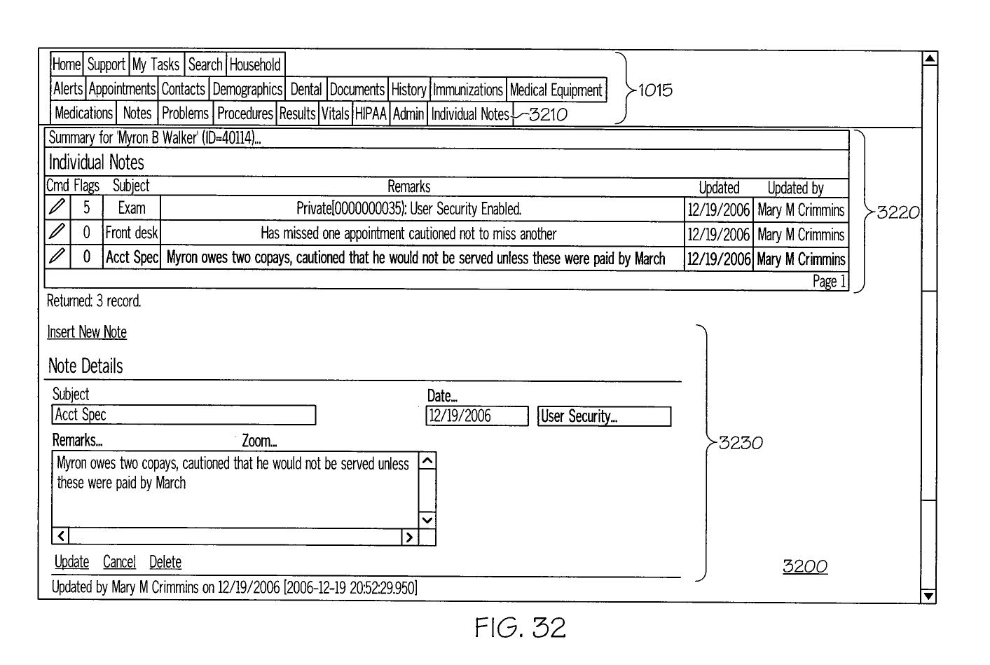

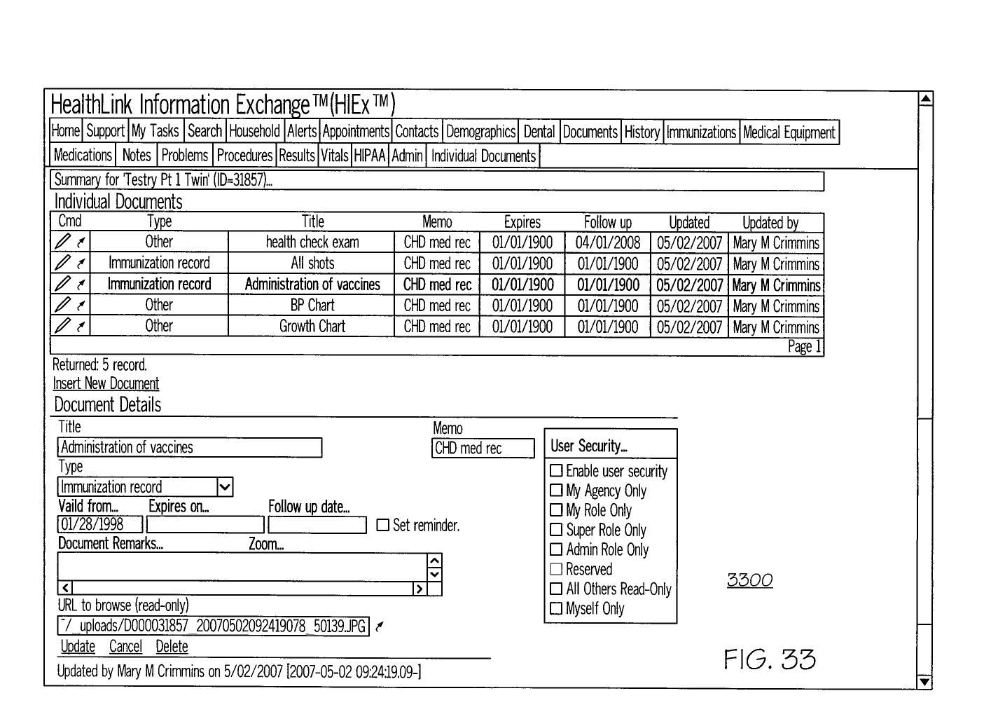

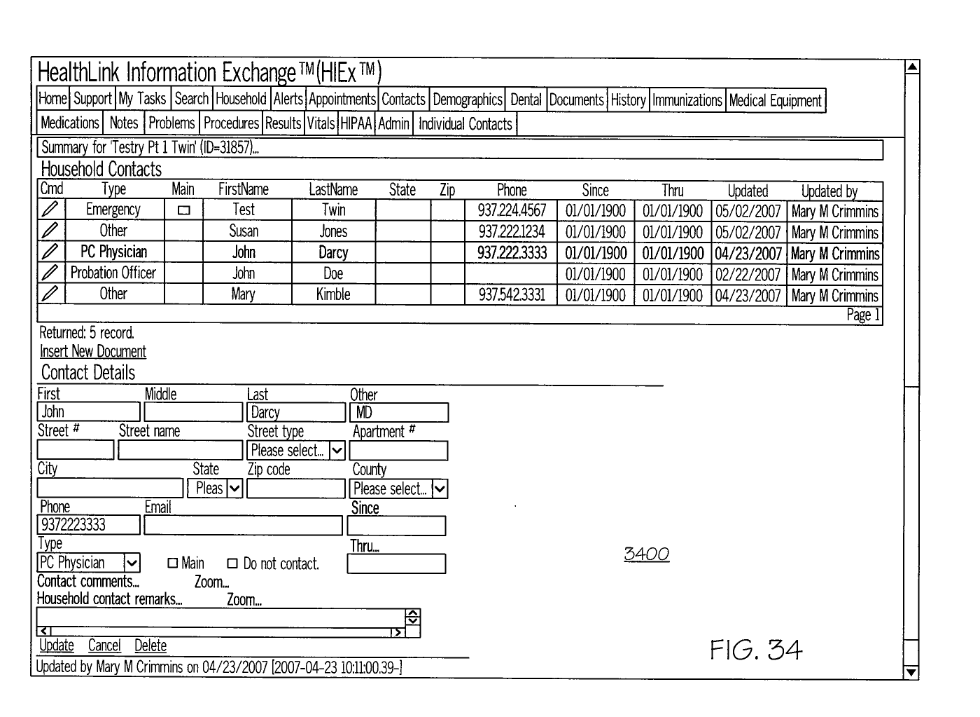

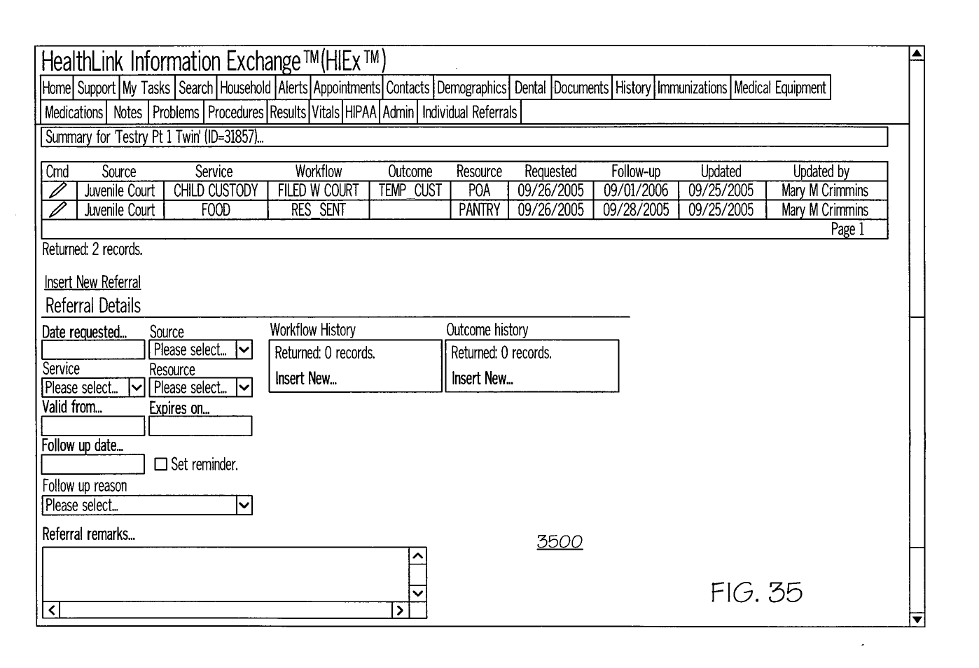

It is to be appreciated that additional pages are included in the private web site 1010, such as for example, an Individual Immunization page 2700 (FIG. 27), an Individual Problems page 2800 (FIG. 28), an Individual Medication summary page 2900 (FIG. 29), an Individual Medication details page 3000 (FIG. 30), an Individuals Procedure page 3100 (FIG. 31), an Individual Note page 3200 (FIG. 32) providing individual notes, as well as an Individual Documents page 3300 (FIG. 33) providing scanned document concerning the individual, an Individual Contacts page 3400 (FIG. 34) providing addition contacts of the individual, and an Individual Referrals page 3500 (FIG. 35) providing the referrals of the individual. As the Individual Documents page 3300, the Individual Contacts page 3400, and the Individual Referrals page 3500 provide the same information and detail section functions as the Household Document page 2600 (FIG. 26), the Household Contacts page 2400 (FIG. 24), and the Household Referrals page 2500 (FIG. 25), respectively, except pertaining to the individual and not the household, for brevity, no further discussion on these pages 3300, 3400, and 3500 is provided.

Referring to FIG. 27, data such as shot, medication, and prescription for each household member is recorded via the Individual Immunization page 2700. As mentioned previously above, the Individual Immunization page 2700 is viewed by the user by selecting the Person health action icon 1696 (FIG. 16A) from the action icon section 1610 of main grid 1600 on search result page 1400 (FIG. 16) or selecting a Individual Immunization tab 2720 when provided in the tab navigation bar 1015. An alert section 2720 is provided on the page 2700 to bring to the user's attention any special alerts 2722, allergies 2724, and medications 2726 of the individual, each with a date and description. Clicking on any of the listed description in the alert section 2720 with bring up the details of the alert, allergies, or medication on an alert page (not shown), which is also accessible view a Alerts tab 2730 when provided in the navigation tab bar 1015.

An Individual Immunization summary section 2740 lists the immunizations of the individual and provides tabulated information such as for example, vaccine group, status, status data, expire on date, last dose date, next dose date, administer by, update date and updated by information. As with the other pages of the private web site 1010, clicking on cell in the summary section 2740 will populate the fields provided in an Immunization Detail section 2750. As the fields shown in the Immunization Detail section 2750 are either self explanatory or function in the same manner as other similar fields in other Details sections of the private web site 1010, for brevity, no further details regarding are provided.

Referring to FIG. 28, an Individual Problems page 2800 is shown which, as with the Individual Immunization page 2700, shows the alert section 2720. The Individual Problems page 2800 is accessible by the user from an Problems tab 2810 when provided in the navigation tab bar 1015 and also lists in a Individual Problems summary section 2820 the problems of the individual. Problem details are viewable by selecting on any of the listed problems in the Individual Problems summary section 2820 which populates the fields provided in a Problem Details section 2830. As the fields shown in the Problem Details section 2830 are either self explanatory or function in the same manner as other similar fields in other Details sections of the private web site 1010, for brevity, no further details regarding are provided.

Referring to FIG. 29, an Individual Medication page 2900 is shown which, as with the Individual Immunization page 2700, shows the alert section 2720. The Individual Medications page 2900 is accessible by the user from an Individual Medication tab 2910 when provided in the navigation tab bar 1015 and also lists in an Individual Medications summary section 2920 the medications of the individual. Query box 2930 and query result section 2940 are provided which provides the user a RX dictionary and an auto insert function 2950 which populates a medication description, medical direction, and compliance information in a detail section for adding a new medication. It is to be appreciated that the RX dictionary is supported by the Unified Medical Language System from the National Library of Medicine and is based on the standards described in the Continuity of care Record from ASTM. Specifically, in one embodiment, drugs are keyed to RXNORM, and problems and procedures are keyed to SNOMED CT. For example, if a user types in “zym” a list like ZYMAR, ZYMINE, ZYMINE-HC, ZYMINE-D, with a list of generic names associated is provided. Dosage data is captured, as well as who filled the prescription, who administered the medication, and a patient report to track actual usage. As shown by FIG. 30, medication details are viewable by selecting on any of the listed medications in the Individual Medications summary section 2920 which populates the fields provided in a Medication Details section 2960. As the fields shown in the Medication Details section 2960 are either self explanatory or function in the same manner as other similar fields in other Details sections of the private web site 1010, for brevity, no further details regarding are provided.

Referring to FIG. 31, an Individual Procedures page 3100 is shown which, as with the Individual Immunization page 2700, shows the alert section 2720. The Individual Procedures page 3100 is accessible by the user from a Procedures tab 3110 when provided in the navigation tab bar 1015 and also lists in a Individual Procedures summary section 3120 the procedures for the individual. Procedure details are viewable by selecting on any of the listed procedures in the Individual Procedures summary section 3120 which populates the fields provided in a Procedure Details section 3130. As the fields shown in the Procedure Details section 3130 are either self explanatory or function in the same manner as other similar fields in other Details sections of the private web site 1010, for brevity, no further details regarding are provided.

Referring to FIG. 32, an Individual Notes page 3200 is shown which is accessible by the user from a Notes tab 3210 when provided in the navigation tab bar 1015 and also lists in a Individual Notes summary section 3220 notes on the individual. Note details are viewable by selecting on any of the listed notes in the Individual Notes summary section 3220 which populates the fields provided in a Note Details section 3230. As the fields shown in the Note Details section 3230 are either self explanatory or function in the same manner as other similar fields in other Details sections of the private web site 1010, for brevity, no further details regarding are provided.

Referring now generally to the implementation of the above-described embodiments, many alternative approaches can be employed to achieve these embodiments. For example, selection devices for manipulating the cursor and other screen images or HTML objects can include a mouse, trackball, touch screen, light pointer, or optical or ultrasonic three-dimensional pointing system. Further types of input devices might include voice recognition, which includes voice dictation software. It is further to be appreciated that other pages, such as the alert page, vitals page, HIPPA page, admin page, medical equipment page, dental page, appointments page, results page, are not described herein but also form part of the invention, and as some aspects may be conventional are not described for brevity of the description.

In one embodiment, the system architecture is based on the Microsoft Systems Architecture. The application also uses the ASP.NET Portal Application software. An embodiment of the present invention may be written using JAVA, C, and the C++ language and utilize object oriented programming methodology (OOP), such as encapsulation, inheritance, polymorphism, composition-relationship, and application frameworks. The benefits of OOP can be summarized, as follows. Objects and their corresponding classes break down complex programming problems into many smaller, simpler problems. Encapsulation enforces data abstraction through the organization of data into small, independent objects that can communicate with each other. Encapsulation protects the data in an object from accidental damage, but allows other objects to interact with that data by calling the object's member functions and structures.

Subclassing and inheritance make it possible to extend and modify objects through deriving new kinds of objects from the standard classes available in the system. Thus, new capabilities are created without having to start from scratch. Polymorphism and multiple inheritances make it possible for different programmers to mix and match characteristics of many different classes and create specialized objects that can still work with related objects in predictable ways. Class hierarchies and containment hierarchies provide a flexible mechanism for modeling real-world objects and the relationships among them.

Application frameworks free application programmers from the chores involved in displaying menus, windows, dialog boxes, and other standard user interface elements for personal computers. An event loop monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created repeatedly for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries. Class libraries are essentially collections of behaviors that the user can call when the user want those individual behaviors in the user program. A framework, on the other hand, provides not only behavior but also the protocol or set of rules that govern the ways in which behaviors can be combined, including rules for what a programmer is supposed to provide versus what the framework provides. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems. Thus, through the development of frameworks for solutions to various problems and programming tasks, significant reductions in the design and development effort for software can be achieved.

A virtual private network (VPN) is a private data network that makes use of the public telecommunication infrastructure, maintaining privacy using a tunneling protocol and security procedures. A virtual private network can be contrasted with a system of owned or leased lines that can only be used by one company. The idea of the VPN is to give the company the same capabilities at much lower cost by using the shared public infrastructure rather than a private one. Phone companies have provided secure shared resources for voice messages. A virtual private network makes it possible to have the same secure sharing of public resources for data. Companies today are looking at using a private virtual network for both extranet and wide-area intranet.

Using a virtual private network involves encrypting data before sending it through the public network and decrypting it at the receiving end. An additional level of security involves encrypting not only the data but also the originating and receiving network addresses. Microsoft, 3Com, and several other companies have developed the Point-to-Point Tunneling Protocol (PPTP) and Microsoft has extended Windows NT to support it. VPN software is typically installed as part of a company's firewall server.

Transmission Control Protocol/Internet Protocol (TCP/IP) is the basic communication language or protocol of the Internet. It can also be used as a communications protocol in a private network (either an intranet or an extranet). When the user is set up with direct access to the Internet, the user computer is provided with a copy of the TCP/IP program just as every other computer that the user may send messages to or get information from also has a copy of TCP/IP.

TCP/IP is a two-layer program. The higher layer, Transmission Control Protocol, manages the assembling of a message or file into smaller packets that are transmitted over the Internet and received by a TCP layer that reassembles the packets into the original message. The lower layer, Internet Protocol, handles the address part of each packet so that it gets to the right destination. Each gateway computer on the network checks this address to see where to forward the message. Even though some packets from the same message are routed differently than others, they will be reassembled at the destination.

TCP/IP uses the client server model of communication in which a computer user (a client) requests and is provided a service (such as sending a Web page) by another computer (a server) in the network. TCP/IP communication is primarily point-to-point, meaning each communication is from one point (or host computer) in the network to another point or host computer. TCP/IP and the higher-level applications that use it are collectively said to be “stateless” because each client request is considered a new request unrelated to any previous one (unlike ordinary phone conversations that require a dedicated connection for the call duration). Being stateless frees network paths so that everyone can use them continuously. Note that the TCP layer itself is not stateless as far as any one message is concerned. Its connection remains in place until all packets in a message have been received.

Many Internet users are familiar with the even higher layer application protocols that use TCP/IP to get to the Internet. These include the World Wide Web's Hypertext Transfer Protocol (HTTP), the File Transfer Protocol (FTP), Telnet (Telnet) which lets the user logon to remote computers, and the Simple Mail Transfer Protocol (SMTP). These and other protocols are often packaged together with TCP/IP as a “suite.”

Personal computer users usually get to the Internet through the Serial Line Internet Protocol (SLIP) or the Point-to-Point Protocol (PPP). These protocols encapsulate the IP packets so that they can be sent over a dial-up phone connection to an access provider's modem.

Protocols related to TCP/IP include the User Datagram Protocol (UDP), which is used instead of TCP for special purposes. Other protocols are used by network host computers for exchanging router information. These include the Internet Control Message Protocol (ICMP), the Interior Gateway Protocol (IGP), the Exterior Gateway Protocol (EGP), and the Border Gateway Protocol (BGP).

Internetwork Packet Exchange (IPX) is a networking protocol from Novell that interconnects networks that use Novell's NetWare clients and servers. IPX is a datagram or packet protocol. IPX works at the network layer of communication protocols and is connectionless (that is, it doesn't require that a connection be maintained during an exchange of packets as, for example, a regular voice phone call does). Packet acknowledgment is managed by another Novell protocol, the Sequenced Packet Exchange. Other related Novell NetWare protocols are: the Routing Information Protocol (RIP), the Service Advertising Protocol (SAP), and the NetWare Link Services Protocol (NLSP).

Hypertext Markup Language (HTML) is the set of markup symbols or codes inserted in a file intended for display on a World Wide Web browser page. The markup tells the Web browser how to display a Web page's words and images for the user. Each individual markup code is referred to as an element (but many people also refer to it as a tag). Some elements come in pairs that indicate when some display effect is to begin and when it is to end.

HTML is a formal Recommendation by the World Wide Web Consortium (W3C) and is generally adhered to by the major browsers, Microsoft's Internet Explorer and Netscape's Navigator, which also provide some additional non-standard codes. The current version of HTML is HTML 4.0. However, both Internet Explorer and Netscape implement some features differently and provide non-standard extensions. Web developers using the more advanced features of HTML 4 may have to design pages for both browsers and send out the appropriate version to a user. Significant features in HTML 4 are sometimes described in general as dynamic HTML. HTML 5 is an extensible form of HTML called Extensible Hypertext Markup Language (XHTML).

Extensible Markup Language (XML) is a flexible way to create common information formats and share both the format and the data on the World Wide Web, intranets, and elsewhere. For example, computer makers might agree on a standard or common way to describe the information about a computer product (processor speed, memory size, and so forth) and then describe the product information format with XML. Such a standard way of describing data would enable a user to send an intelligent agent (a program) to each computer maker's Web site, gather data, and then make a valid comparison. XML can be used by any individual or group of individuals or companies that wants to share information in a consistent way.

XML, a formal recommendation from the World Wide Web Consortium (W3C), is similar to the language of today's Web pages, the Hypertext Markup Language (HTML). Both XML and HTML contain markup symbols to describe the contents of a page or file. HTML, however, describes the content of a Web page (mainly text and graphic images) in terms of how it is to be displayed and interacted by a user. For example, a <P> starts a new paragraph. XML describes the content in terms of what data is being described. For example, a <PHONENUM> could indicate that the data that followed it was a phone number. This means that an XML file can be processed purely as data by a program or it can be stored with similar data on another computer or, like an HTML file, that it can be displayed. For example, depending on how the application in the receiving computer wanted to handle the phone number, it could be stored, displayed, or dialed.

XML is “extensible” because, unlike HTML, the markup symbols are unlimited and self-defining. XML is actually a simpler and easier-to-use subset of the Standard Generalized Markup Language (SGML), the standard for how to create a document structure. XML markup, for example, may appear within an HTML page. Early applications of XML include Microsoft's Channel Definition Format (CDF), which describes a channel, a portion of a Web site that has been downloaded to the user hard disk and is then is updated periodically as information changes. A specific CDF file contains data that specifies an initial Web page and how frequently it is updated. Applications related to banking, e-commerce ordering, personal preference profiles, purchase orders, litigation documents, part lists, and many others are anticipated.

Although not limited to, the following are some noted advantages of the present invention. The system 100 provides the technical capability that enables health and human service providers to share protected health information of their clients/patients—through an electronic central data repository. The system 100 is designed to be the public sector outpatient component of a comprehensive regional electronic health information infrastructure that facilitates standards-based electronic communication and real-time sharing of electronic health information records-across multiple providers. Access to a complete set of client/patient information at point of care has been demonstrated to reduce medical errors, and improve both cost and treatment effectiveness. The system 100 has been intentionally developed using originally authored and public domain open-source computer code, and current commercially available software technologies. Business rules demonstrating a commitment to non-proprietary and non-vended products facilitate greater opportunity for interoperability with multiple systems, and greater accessibility to public health and human service safety net providers.

Some other noted, and not to be limited by, characteristics are: mobile device support for WAP/WML and Pocket Browser devices, clean code/html content separation using server controls, pages that are constructed from dynamically-loaded user controls, configurable output caching of portal page regions, and multi-tier application architecture. The system 100 also provides ADO.NET data access using SQL stored procedures, data content tracking and logging, XML serialization and schema support, SOAP support, SMTP and POP3 email support, Microsoft's Windows authentication—username/password in Active DS or NT SAM, and forms authentication using a database for usernames/passwords. Also provided is role-based security to control user access to portal content, user-based security to control user access to application objects, Web Services for interoperability support, Web Services for better usability, SQL Server Reporting Services, and IIS 5.0 and SQL compatibility. The system 100 also uses Microsoft's Server 2000 Applications, Microsoft's Windows 2000 Advanced Server Operating System, system tape backup with remote storage of tapes, Cisco Systems' VPN encryption for secure connections, HIPAA Privacy and Security rule compliance, SNOMED CT integration, and HL7 version 3 standards compliance.

Although not limited to, it is further noted that there are also specific unique components of the system 100 that provide significant advantages over comparable current state of the art products. First, the system 100 is developed for use in an outpatient setting, which is where over 80% of health care services are provided. Second, the system 100 maintains health information records both individually and as a part of a household unit. This is particularly useful for clients/patients whose eligibility for service is tied to household factors such as income, and clinically useful for providers who are working with multiple members of one family. Third, the system 100 has a system of role-based access, which readily facilitates multiple user access to a health information record while protecting access to certain kinds of information as required by federal and state law such as HIPAA. Fourth, each bit of data resident in the system 100 is time, date, and user stamped to insure security and facilitate accountability among multiple users of a central record, while insuring that the records can be readily and routinely updated. All data changes are logged and stored in tables on the server. This further facilitates restoration of data precluding the need to refer to tape back ups and it provides the ability to report log changes.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

What is claimed is:

1. A method ensuring health management for individuals and their related household members receiving care from a variety of disjointed health and human services in a predefined region comprising:
providing shared electronic health information records on the individuals and their related household members which are maintained in a central data server;
recording information, and care and treatment events that have occurred with the variety of disjointed health and human services in the predefined region to the individuals and their related household members in the shared electronic health information records;
implementing a health information exchange system configured to permit presenting of the information and care and treatment events from the shared electronic health information records on selected ones of the individuals and their related household members to permit coordinating assistance from linked care givers, and to permit tracking of recommended care and treatment events to ensure compliance by the selected ones of the individuals and their related household members in receiving the recommended care and treatment; and
permitting the linked care givers to access the health information exchange system over a public network via a secure private web site, thereby defining a regional electronic health information network in the predefined region.

2. The method according to claim 1 wherein the linked care givers are healthcare professionals, public health agencies, pharmacies, governmental agencies, school clinics, and social service organizations.

3. The method according to claim 1 further comprising relating the individuals and their related household members by head of household identification numbers.

4. The method according to claim 1 wherein the selected ones of the individuals and their related household members are determined from performing a query on the shared electronic health information records.

5. The method according to claim 1 wherein the selected ones of the individuals and their related household members are determined by electronically querying the shared electronic health information records, wherein the querying is performed by inputting at least one search term in a search box providing a first name field, a middle name field, a last name field, a date of birth (DOB) field, a phone number field, a social security number (SSN) field, and a head of household identification number (HHsID) field.

6. The method according to claim 1 wherein the selected ones of the individuals and their related household members are determined by electronically querying the shared electronic health information records, wherein the querying is performed by selecting at least one filter in a search providing filters for a registry agency filter, a registry sources filter, a registry statuses filter, an all records filter, an assignable advocate filter, a referral source filter, and a service requested filter.

7. The method according to claim 1 wherein the selected ones of the individuals and their related household members are determined by electronically querying the shared electronic health information records, wherein the querying is performed by selecting at least one option in a search providing an option searching only the health information records assigned to a user, an option searching only the health information records of those individual identified as uninsured, an option searching only those health information records identified as a head of household, and options searching time periods for a registry date range, a referral date range, and a follow up date range.

8. The method according to claim 1 wherein the selected ones of the individuals and their related household members are determined from performing a query on the shared electronic health information records, and the query returns matching ones of the shared electronic health information records on a search result page displaying selectable action icons for each returned health information record.

9. The method according to claim 8 wherein the selectable action icons include a first action icon which when selected displays a summary page of a selected individual and any related household members, a second action icon which when selected displays a registry page of the selected individual and any related household members, a third icon which when selected displays a household referrals page, a fourth action icon which when selected displays an electronic document for a government program application, and a fourth action icon which when selected displays an immunization page present immunization information from the shared electronic health information record of the selected individual.

10. The method according to claim 9 wherein the summary page of a selected individual and any related household members presents information from the shared electronic health information records on first name, last name, middle name, date of birth, social security number, self-reported health issues, special groups classifications, insurance information, and income information for the selected individual and any related household members.

11. The method according to claim 9 wherein the registry page of the selected individual and any related household members presents information from the shared electronic health information records on first name, last name, middle name, date of birth, social security number, demographics, self-reported health issues, special groups classifications, insurance information, income information, household addresses, household contacts for the selected individual and any related household members.

12. The method according to claim 1 further comprises presenting to an authorized user on the secure private web site a web page having posting area sections providing information about developing practices and changes in methods of using the health information exchange system, and error events.

13. The method according to claim 1 further comprising presenting to an authorized user on the secure private web site a web page providing user contact information and user document information.

14. The method according to claim 1 further comprising presenting to an authorized user on the secure private web site a web page having a form permitting the authorized user to enter information on an individual into a new shared electronic health information record.

15. The method according to claim 14 wherein the form is used to enter a first name, a last name, a middle name, a date of birth, a social security number, demographics, self-reported health issues, any special groups classification, insurance information, income information, household addresses, and household contacts on the individual and any related household members into the new shared electronic health information record, wherein the individual and the any related household members are associated in the relational database by a household identification number (HHsID).

16. The method according to claim 14 further comprising permitting the authorized user to enter a reminder into the new shared electronic health information record to contact the individual at a later date to gather additional information on the individual for entry into the new shared electronic health information record.

17. The method according to claim 1 further comprising presenting to an authorized user on the secure private web site a web page having a form permitting the authorized user to enter information on an individual into a new shared electronic health information record, wherein the information includes problems of the individual and the any related household members, referrals of the individual and the any related household member, notes on the individual and the any related household members, immunization details on the individual and the any related household members, medication details on the individual and the any related household members, and procedures for the individual and the any related household members.

18. The method according to claim 1 further comprising presenting to an authorized user on the secure private web site a web page presenting information on an individual, wherein the information includes problems of the individual, referrals of the individual, notes on the individual, immunization of the individual, medication of the individual, and procedures for the individual.

19. The method according to claim 1 implemented over a virtual private network.

20. A network system implementing the method according to claim 1.
